(19) United States
(12) Patent Application Publication
(10) Pub. No.: US 2026/0015443 A1
(43) Pub. Date: Jan. 15, 2026

(54) POLYPROPLYENE COMPOSITIONS WITH ENHANCED STRAIN HARDENING AND METHODS OF PRODUCING THE SAME

(71) Applicant: ExxonMobil Chemical Patents Inc., Baytown, TX (US)

(72) Inventors: George J. PEHLERT, Houston, TX (US); Ramkiran MATTUPALLI, Singapore (SG); Hersimran Mark Singh CHAHL, Friendswood, TX (US)

(73) Assignee: ExxonMobil Chemical Patents Inc., Baytown, TX (US)

(21) Appl. No.: 18/995,263

(22) PCT Filed: Jul. 13, 2023
(86) PCT No.: PCT/US2023/027617

§ 371 Date: Jan. 16, 2025

Related U.S. Application Data
(60) Provisional application No. 63/369,630, filed on Jul. 27, 2022.

(51) Int. Cl. C08F 210/16

(52) U.S. Cl. CPC C08F 210/16; C08F 2800/20

(57) ABSTRACT

Polymer compositions can include a first polymer component containing polypropylene; a second polymer component containing a high molecular weight copolymer having a weight average molecular weight of greater than about 1 MDa; wherein the polymer composition has a peak extensional viscosity (non-annealed) at a strain rate of 1/sec (190° C.) of greater than 55 kPa·s. Methods can include preparing a polypropylene composition by a multistage polymerization including a first stage generating a propylene polymer, and a second stage generating a high molecular weight copolymer having a weight average molecular weight of greater than about 1 MDa; wherein the polymer composition has a peak extensional viscosity (non-annealed) at a strain rate of 1/sec (190° C.) of greater than 55 kPa·s.

### FIELD OF THE INVENTION

The presently disclosed subject matter relates to polypropylene compositions having balanced strain hardening and melt strength and methods of producing same.

### BACKGROUND OF THE INVENTION

Polypropylene compositions are widely used in a number of commercial applications, but the melt strength and strain hardening properties of the materials limit compatibility with various manufacturing techniques. Particularly, standard linear polypropylenes exhibit poor performance in industrial operations that involve both shear and extensional flows, such as thermoforming, fiber drawing/spinning, blown film, foam, and the like. This is partially due to its low melt strength and lack of strain hardening in common linear polypropylene. Multiple approaches have been attempted in the industry to improve the melt strength and strain hardening of polypropylenes including increasing the molecular weight, broadening of the molecular weight distribution, addition of an ultra-high molecular weight tail, and/or the addition of long chain branching (LCB).

Polypropylene compositions having a high molecular weight tail can be produced by physical blending and/or through the use of reactor cascades in which polypropylenes of different molecular weights are produced in different reactors and are later combined. Melt blending of polypropylene components, however, often yields poor results such as low melt strength, reduced yield, and modest increases in strain hardening. Separately producing polypropylene fractions can increase production costs and generate polymer that is marginally stiffer, but that may have reduced toughness due to lower entanglement density and/or insufficient homogeneity.

### SUMMARY OF THE INVENTION

The present disclosure is directed to broad molecular weight polypropylene compositions having a high molecular weight generated through multistage polymerization processes.

In an aspect, compositions disclosed herein are directed to polymer compositions including a first polymer component containing polypropylene; a second polymer component containing a high molecular weight copolymer having a weight average molecular weight of greater than about 1 MDa; wherein the polymer composition has a peak extensional viscosity (non-annealed) at a strain rate of 1/sec (190° C.) of greater than 55 kPa·s.

In another aspect, methods include preparing a polypropylene composition by a multistage polymerization including a first stage generating a propylene polymer, and a second stage generating a high molecular weight copolymer having a weight average molecular weight of greater than about 1 MDa; wherein the polymer composition has a peak extensional viscosity (non-annealed) at a strain rate of 1/sec (190° C.) of greater than 55 kPa·s.

### BRIEF DESCRIPTION OF THE DRAWINGS

FIG. 1 is a schematic diagram of the two-stage polymerization process for producing polypropylene compositions having a high molecular weight tail.

FIG. 2 is a schematic diagram of a multi-stage polymerization process with two gas phase reactors for producing polypropylene compositions having a high molecular weight tail.

FIG. 3 is a schematic diagram of a multi-stage polymerization process with a pre-polymerization reactor for producing polypropylene compositions having a high molecular weight tail.

FIG. 4 is a graphical representation showing molecular weight distributions for comparative polypropylenes produced by conventional processes.

FIG. 5 is a graphical representation showing molecular weight distributions for comparative polypropylenes produced by conventional processes.

FIG. 6 is a graphical representation showing extensional viscosity as a function of step time for a polypropylene composition prepared in accordance with the present disclosure.

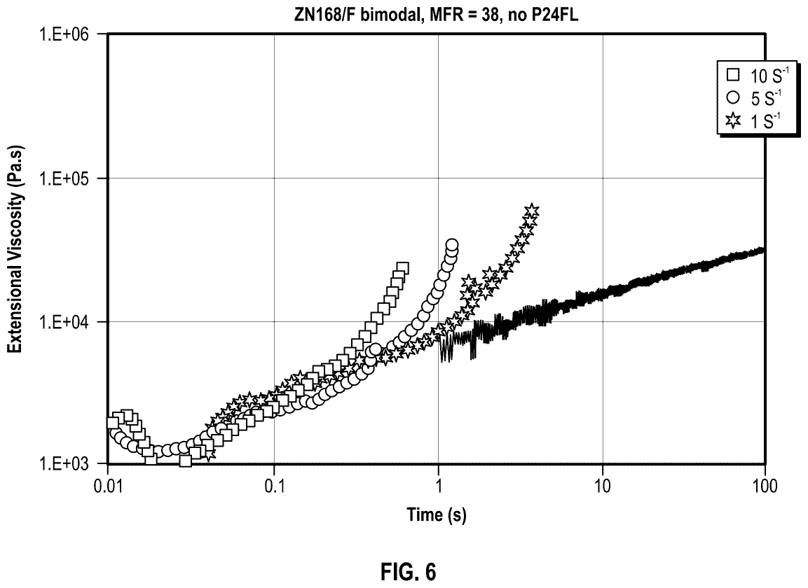

FIG. 7 is a graphical representation showing extensional viscosity as a function of step time for a comparative polypropylene composition.

FIG. 8 is a graphical representation showing extensional viscosity as a function of step time for a polypropylene composition prepared in accordance with the present disclosure.

FIG. 9 is a graphical representation showing extensional viscosity as a function of step time for a polypropylene composition prepared in accordance with the present disclosure.

### DETAILED DESCRIPTION OF THE INVENTION

The present disclosure is directed to the generation of broad molecular weight polypropylene compositions having a high molecular weight fraction (“a high molecular weight tail” or “high MW tail”) generated through multistage polymerization processes. In any embodiment, polypropylene compositions may include a first polymer component and a second polymer component forming a high MW tail having a weight average molecular weight of greater than about 1 MDa that increases the peak extensional viscosity and strain hardening ratio. Polypropylene compositions may exhibit an increase in shear thinning, melt strength and strain hardening, which may be suitable for applications including, but not limited to, foaming, blown film, thermoforming and extrusion profiles.

For the purposes of this disclosure, the following definitions will apply:

As used herein, the terms “a” and “the” as used herein are understood to encompass the plural as well as the singular.

As used herein, the term “density” refers to the density of a polymer independent of any additives, such as antiblocks, which can change the tested value. Density is measured in accordance with ASTM D-1505.

As used herein, the term “melt flow rate” or “MFR” is the number of grams extruded in 10 minutes under the action of a standard load and is an inverse measure of viscosity. A high MFR implies low viscosity and low MFR implies high viscosity. In addition, polymers are shear thinning, which means that their resistance to flow decreases as the shear rate increases. This is due to molecular alignments in the direction of flow and disentanglements. As provided herein, MFR (I2, 230° C., 2.16 kg) is determined according to ASTM D-1238-E(20).

As used herein, “Mₙ” is number average molecular weight, “M_{w}” is weight average molecular weight, and “M_{z}” is z-average molecular weight. Unless otherwise noted, all molecular weight units (e.g., M_{w}, Mₙ, M_{z}) including molecular weight data are in the unit of g/mol.

As used herein, molecular weight distribution (“MWD”) is equivalent to the expression M_{w}/Mₙ and is also referred to as polydispersity index (PDI). The expression M_{w}/Mₙ is the ratio of the M_{w} to the Mₙ. The M_{w} is given by:

$${M}_{w} = \frac{{\sum }_{i} {n}_{i} {M}_{i}^{2}}{{\sum }_{i} {n}_{i} {M}_{i}}$$

the Mₙ is given by:

$${M}_{n} = \frac{{\sum }_{i} {n}_{i} {M}_{i}}{{\sum }_{i} {n}_{i}}$$

the M_{z} is given by:

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of M_{w}, M_{z}, and Mₙ are typically determined by Gel Permeation Chromatography as disclosed in Macromolecules, Vol. 34, No. 19, pg. 6812 (2001).

As used herein, “strain hardening” or cold working, is the strengthening of a polymer when exposed to forces of deformation. “Strain hardening” manifests as the increase in stress that is required to cause an increase in strain as a polymer is plastically deformed. A TA Instruments ARES-G2 mechanical spectrometer was used to measure strain hardening of the polypropylene samples.

“Strain hardening ratio” is defined as the ratio of two extensional viscosities: the numerator measured using an extensional viscometer reporting the maximum viscosity (at break), and the denominator being an extensional viscosity calculated from small amplitude strain experimental data using the method of Baumgaertel and Winter. It is understood that the two extensional viscosities are measured using the same experimental conditions (i.e., temperature, stabilization, etc.).

The conventional molecular weight (IR M_{W}) is determined by combining universal calibration relationship with the column calibration which is performed with a series of monodispersed polystyrene (PS) standards ranging from 700 to 10M gm/mole. The M_{W} at each elution volume is calculated with the following equation:

$$log M = \frac{log ( {K}_{PS} / K )}{a + 1} + \frac{{a}_{PS} + 1}{a + 1}$$

where the variables with subscript “PS” stand for polystyrene while those without a subscript are for the test samples. In this method, aPS=0.67 and KPS=0.000175 while a and K are for other materials as calculated and published in literature (Sun, T. et al., Macromolecules, 2001, 34, 6812), except that for purposes of the present disclosure, a=0.695 and K=0.000579 for linear ethylene polymers, a=0.705 and K=0.0002288 for linear propylene polymers, a=0.695 and K=0.000181 for linear butene polymers, a is 0.695 and K is 0.000579*(1-0.0087*w2b+0.000018*(w2b)^{A}2) for ethylene-butene copolymer where w2b is a bulk wt. % of butene comonomer, a is 0.695, and K is 0.000579*(1-0.0075*w2b) for ethylene-hexene copolymer where w2b is a bulk wt. % of hexene comonomer, and a is 0.695 and K is 0.000579*(1-0.0077*w2b) for ethylene-octene copolymer where w2b is a bulk wt. % of octene comonomer. Concentrations are expressed in g/cm³, molecular weight is expressed in g/mole, and intrinsic viscosity (hence K in the Mark-Houwink equation) is expressed in dL/g unless otherwise noted.

As used herein, the term “polypropylene” refers to homopolymers of propylene monomer (propylene-derived units).

A “reactor” is any type of vessel or containment device in any configuration of one or more reactors, and/or one or more reaction zones, wherein a similar polymer is produced; however, two or more reactors that are fluidly connected with one another can each produce a different polymer.

As used herein, the terms “slurry polymerization,” “slurry,” and “slurry polymerization reactor” each refer to a process where an olefin (e.g, propylene) is partly dissolved or not dissolved in the polymerization medium. During slurry polymerization, catalyst components, solvent, a-olefins and hydrogen can be passed under pressure to one or more slurry polymerization reactors. Typically, catalyst components are fed to the slurry polymerization reactor as a mixture in aliphatic hydrocarbon solvent, in oil, a mixture thereof, or as a dry powder.

The term “gas phase polymerization” refers to the production of polymer in a gas phase reactor.

As used herein, the term “high molecular weight tail” or “high MW tail” refers to polymer component including polymer chains having a weight average molecular weight greater than about 1 MDa. Specifically, performing gel permeation chromatography on a polypropylene composition having a high molecular weight tail will generate a multimodal molecular weight distribution in which the area under the curve at higher molecular weights produces an apparent hump, shoulder, or tail.

As used herein, “melt strength” refers to the resistance of a polymer melt to stretching. The melt strength of a material is related to the molecular chain entanglements of the polymer and its resistance to untangling under strain. The polymer properties affecting the resistance to untangling are molecular weight, molecular-weight distribution (MWD) and molecular branching. It is determined herein determined using an extensional rheometer at 190° C. The melt strength of a polymer at a particular temperature, e.g., 190° C., can be determined with a Gottfert Rheotens Melt Strength Apparatus (e.g., Gottfert Rheotens 71.97). The measurement is accomplished by grasping the extrudate from a capillary rheometer (e.g., a Gottfert Rheograph 2002 capillary rheometer), or from an extruder equipped with a capillary die, after the extrudate has been extruded 100 mm using variable speed gears and increasing the gear speed at a constant acceleration (12 mm/s², starting from an initial, zero-force calibration velocity of 10 mm/s) until the molten polymer strand breaks. The force in the strand is measured with a balance beam in conjunction with a linear variable displacement transducer. The force required to extend and then break the extrudate is defined as the melt strength. The force is measured in centinewtons (cN). A typical plot of force vs. wheel velocity is known in the art to include a resonate immediately before the strand breaks. In such cases, the plateau force is approximated by the midline between the oscillations.

As discussed above, previous methods of generating polypropylenes having a high MW tail typically utilize one or more of physical blending and specialized catalyst/donor systems. However, current approaches may have various tradeoffs in physical properties of the resulting polypropylene compositions. In physical blending, for example, dispersion of the high MW fraction can be limited due to the viscosity mismatch with the bulk polypropylene fraction, while processing may also induce thermo-mechanical degradation of the high MW tail component. Similarly, the use of catalysts/donor systems can enhance extensional viscosity as a function of MFR, but as MFR increases the proportion of the high MW tail component typically decreases, reducing melt strength and elasticity.

Reactor processing design have also been implemented in a number of variations to generate high MW tails in the form of multistage polymerization methods. Multistage polymerization methods may include the use of multiple reactors, such as the use of pre-polymerization loops (or “baby loops”), slurry polymerization reactors (or “slurry loops”), and one or more gas phase reactors. By selective control through the series of reactors, distinct polymer fractions can be generating in a single continuous process. In some cases, a first polymer fraction can be generated in a polymerization stage and transferred to subsequent stages where additional polymer fractions are generated in the presence of the first polymer fraction or through modification of the first polymer fraction.

Generally, decreasing the MFR of the polymer composition involves reducing the concentration of chain transfer agents such as hydrogen used during polymerization, which allows greater polymer chain extension and the production of higher MW polymer fractions. However, reducing the concentration of chain transfer agent can also decrease catalyst activity and overall production rate. Another compounding factor is residence time in the reactor stage, which typically limits the maximum proportion of high MW tail and the associated physical property modifications that can be generated.

Methods disclosed herein include the preparation of polypropylene compositions by multistage polymerization having a broad MWD and varying concentrations of high MW tail and enhanced extensional viscosity, melt strength, strain hardening and step-out properties. Polypropylene compositions disclosed herein may include a mixture of a first polypropylene polymer or copolymer and a second high MW tail component dispersed therein. In some cases, the first polymer component may contain a polypropylene polymer or copolymer, which can have a MWD of about 6.5 to about 8.5. The second high MW tail component may have a weight average molecular weight of greater than about 1 MDa, which is present at a percent by weight (wt %) of about 2 wt % or greater. In some cases, polypropylene compositions may include a high MW tail at a percent by weight (wt %) of high MW tail in a range of about 2 wt % to about 15 wt %, about 2 wt % to about 12 wt %, or about 2 wt % to about 12 wt %. In some cases, polypropylene compositions may have an overall MWD of at least 10 and an M_{z} of at least 100 kDa.

Methods disclosed herein may include multistage polymerization processes having a first stage in which a polypropylene polymerization reaction produces a first polypropylene or copolymer and a second stage that produces a second polymer forming a high MW tail component. The high MW tail may be generated in a single reactor (or reactor stage containing multiple reactors) prior to or subsequent to the generation of the first polypropylene polymer or copolymer. In some cases, a high MW tail component may be generated at multiple points (e.g, within one or more reactors and/or stages) throughout a multistage polymerization process, including the generation of multiple fractions at two or more points. Processes described herein may be used in combination with other techniques to tune strain hardening and melt strength, including post-reactor modification by crosslinking or blending with other polymers and additives. Multistage polymerization processes disclosed herein may also include the generation of multiphase copolymer compositions such as impact copolymers by polymerization and/or crosslinking of an internal phase within a polypropylene polymer fraction.

Multistage polymerization processes disclosed herein are relatively modular and may include various prepolymerization methods and reactor arrangements. Processes may include use of the pre-polymerization loop (e.g. baby loop), slurry phase loops/reactors, and/or gas phase reactors. Commercial reactor arrangements can include the ExxonMobil or Spheripol™ process (1 or 2 slurry loops plus 1, 2 or 3 gas phase reactors in series). By selective control of the pre-polymerization reactor, slurry phase and/or gas phase reactor(s), a high molecular tail of differing concentration, co-monomer or ter-monomer composition, molecular weight, molecular weight distribution can be made resulting in a polypropylene composition having a broad molecular weight distribution and a high molecular weight tail.

Multistage polymerization processes disclosed herein may control the proportion and weight average weight of the high MW tail by one or more of comonomer feed, chain transfer agent concentration, and residence time within the reactor. In some cases, methods disclosed herein may generate increased fractions of high MW tail through the addition of a comonomer, such as ethylene, having a higher reactivity with the selected catalyst relative to the primary propylene monomer (or comonomer mixture). Comonomers suitable for the polymerization methods disclosed herein include C₁ to C₂₀ olefins such as ethylene, propylene, butene, hexene, octene, and the like; and polyunsaturated C₁ to C₂₀ monomers such as butadiene, norbornene, ethylidene norbornene, vinyl norbornene, 1,4-hexadiene, 1,5-hexadiene, 1,6-heptadiene, 1,6-octadiene, 1,7-octadiene, 1,8-nonadiene, 1,9-decadiene, 1,11-docadiene, and the like; and mixtures thereof.

Comonomer may be added at a mole percent of the total monomer mole content (mol %) in a range of about 1 mol % to about 10 mol %, about 1 mol % to about 7 mol %, or about 2 mol % to about 5 mol %. In some embodiments, comonomer may be added at about 1 mol % or more, about 2 mol % or more, or about 4 mol % or more. Polypropylene compositions produced by the present methods can have a percent by weight (wt %) of comonomer as determined by Fourier transform infrared (FTIR) spectroscopy in a range of about 2 wt % to about 10 wt %.

The concentration of the chain transfer agent may be modified in at least one of the first stage and the second stage to control the overall molecular weight of the polymer being generated in the respective stage. In any embodiment, the molar ratio of chain transfer agent (e.g., hydrogen) to monomer reactant (e.g., propylene, olefin, or comonomer mixture) in a reactor or stage may be between about 0 to about 0.5, about 0.01 to about 0.5, about 0.02 to about 0.3, about 0.05 to about 0.3, or about 0 to about 0.01.

The proportion and overall molecular weight of the first polypropylene polymer or copolymer and/or high MW tail component may also be controlled by adjusting the residence time within the stages producing the respective components. In any embodiment, residence times in the stage producing the first polypropylene polymer or copolymer can be between about 30 minutes to about 120 minutes, about 40 minutes to about 100 minutes, or about 40 minutes to about 70 minutes. In any embodiment, residence times in the stage producing high MW tail component can be between about 30 minutes to about 240 minutes, about 50 minutes to about 200 minutes, or about 80 minutes to about 150 minutes.

The various stages and components used in the multistage polymerization methods discussed herein are discussed in greater detail in the sections that follow.

### Prepolymerization

Methods disclosed herein may include a prepolymerization step in which one or more monomers are combined in a liquid phase, which may also include one or more reactants or inert components. Prepolymerization can be performed in a continuous stirred tank reactor or a loop reactor and can be conducted at any suitable temperature, such as about 0° C. to about 60° C., about 10° C. to about 50° C., or from about 20° C. to about 45° C. Pressure of the prepolymerization reaction is not critical, but often is maintained such that the reaction mixture is in liquid phase, such as from about 275 psig to about 1435 psig, or from about 420 to about 1000 bar.

During prepolymerization, monomers can be fed into a prepolymerization reactor. The amount of prepolymer generated on a selected catalyst during prepolymerization may range from about 10 to about 1000 g per g of the solid catalyst component, or from about 50 to about 500 g per g of the solid catalyst component. Methods disclosed herein may include recovering catalyst particles from a continuous stirred prepolymerization reactor, where the catalyst particles may have varying amounts of polymer associated therewith that depend on the residence time in the prepolymerization reactor.

Prepolymerization reactions may include introduce of one or more catalyst systems, which may include one or more primary catalysts and/or co-catalysts. Methods disclosed herein may include the addition of a catalyst system at one or more points in a multistage polymerization, such as during prepolymerization and one or more later stages. Other components can be added in the prepolymerization stage, such as chain transfer agents, antistatic agents, promoters, scavenging agents, and the like.

### Catalyst System

Catalyst systems in accordance with the present disclosure can include at least one catalyst, at least one internal electron donor, one or more external electron donors, a co-catalyst, and/or a support where the catalyst system can polymerize propylene monomers to produce a propylene composition under polymerization conditions of suitable temperature and pressure. In addition to the multistage polymerizations methods disclosed herein, propylene compositions may also be produced using multiple catalyst and donor having desired attributes including broad MWD, the MW of the high MW tail and/or the amount of the high molecular weight tail.

In some embodiments, the catalyst system may include a Ziegler-Natta and/or Metallocene catalyst used with one or more donors and co-catalysts, such as solid titanium supported catalyst systems described in U.S. Pat. Nos. 4,990,479 and 5,159,021, and PCT Publication No. WO 00/63261, and others. Briefly, the Ziegler-Natta catalyst can be obtained by: (1) suspending a dialkoxy magnesium compound in an aromatic hydrocarbon that is liquid at ambient temperatures; (2) contacting the dialkoxy magnesium hydrocarbon composition with a titanium halide and with a diester of an aromatic dicarboxylic acid; and (3) contacting the resulting functionalized dialkoxy magnesium-hydrocarbon composition of step (2) with additional titanium halide.

A solid titanium catalyst component can be prepared by contacting a magnesium compound, a titanium compound, and at least the internal electron donor. Examples of the titanium compound used in the preparation of the solid titanium catalyst component include tetravalent titanium compounds having the formula Ti(ORₙ)X₄₋ₙ, wherein “R” is a hydrocarbyl radical, “X” is a halogen atom, and “n” is from 0 to 4. For purposes of this disclosure, a hydrocarbyl radical is defined to be C₁ to C₂₀ radicals, or C₁ to C₁₀ radicals, any of which can be linear, branched, or cyclic where appropriate (aromatic or non-aromatic).

In any embodiment, suitable titanium compounds for use herein include: titanium tetra-halides such as TiCl₄, TiBr₄, and/or TiI₄; alkoxy titanium trihalides including Ti(OCH₃)Cl₃, Ti(OC₂H₅)Cl₃, Ti(OC₄H₉)Cl₃, Ti(OC₂H₅)Br₃, and/or Ti(O iso-C₄H₉)Br₃; dialkoxytitanium dihalides including Ti(OCH₃)₂Cl₂, Ti(OC₂H₅)₂Cl₂, Ti(O n-C₄H₉)₂Cl₂ and/or Ti(OC₂H₅)₂Br₂; trialkoxytitanium monohalides including Ti(OCH₃)₃Cl, Ti(OC₂H₅)₃Cl, Ti(O n-C₄H₉)₃Cl and/or Ti(OC₂H₅)₃Br; and/or tetraalkoxy titaniums including Ti(OCH₃)₄, Ti(OC₂H₅)₄, and/or Ti(O n-C₄H₉).

In any embodiment, the halogen-containing titanium compound can be a titanium tetrahalide, or titanium tetrachloride. The titanium compounds can be used singly or in combination with each other. The titanium compound can be diluted with a hydrocarbon compound or a halogenated hydrocarbon compound.

In any embodiment, the magnesium compound used in the preparation of the solid titanium catalyst component can include a magnesium compound having reducibility (or capable of alkyl substitution) and/or a magnesium compound having no reducibility. Suitable magnesium compounds having reducibility can, for example, be magnesium compounds having a magnesium-carbon bond or a magnesium-hydrogen bond. Examples of useful magnesium compounds include dimethyl magnesium, diethyl-magnesium, dipropyl magnesium, dibutyl magnesium, diamyl magnesium, dihexyl magnesium, didecyl magnesium, magnesium ethyl chloride, magnesium propyl chloride, magnesium butyl chloride, magnesium hexyl chloride, magnesium amyl chloride, butyl ethoxy magnesium, ethyl butyl magnesium, and/or butyl magnesium halides. These magnesium compounds can be used singly or they can form complexes with the organoaluminum co-catalyst as described herein. These magnesium compounds can be a liquid or a solid. In combination with the magnesium compound, the titanium-based Ziegler-Natta catalyst is said to be supported, thus the solid part of the catalyst.

Suitable examples of the magnesium compounds having no reducibility include: magnesium halides such as magnesium chloride, magnesium bromide, magnesium iodide, and magnesium fluoride; alkoxy magnesium halides, such as magnesium methoxy chloride, magnesium ethoxy chloride, magnesium isopropoxy chloride, magnesium phenoxy chloride, and magnesium methylphenoxy chloride; alkoxy magnesiums, such as ethoxy magnesium, isopropoxy magnesium, butoxy magnesium, n-octoxy magnesium, and 2-ethylhexoxy magnesium; aryloxy magnesiums such as phenoxy magnesium and dimethylphenoxy magnesium; and/or magnesium carboxylates, such as magnesium laurate and magnesium stearate.

In any embodiment, non-reducible magnesium compounds can be compounds derived from the magnesium compounds having reducibility, or can be compounds derived at the time of preparing the catalyst component. The magnesium compounds having no reducibility can be derived from the compounds having reducibility by, for example, contacting the magnesium compounds having reducibility with polysiloxane compounds, halogen-containing silane compounds, halogen-containing aluminum compounds, esters, alcohols, and the like.

In any embodiment, the magnesium compounds having reducibility and/or the magnesium compounds having no reducibility can be complexes of the above magnesium compounds with other metals, or mixtures thereof with other metal compounds. They can also be mixtures of two or more types of the above compounds. In any embodiment, halogen-containing magnesium compounds, including magnesium chloride, alkoxy magnesium chlorides and aryloxy magnesium chlorides can be used.

In any embodiment, a suitable solid catalyst component comprising a non-aromatic internal electron donor can be a catalyst solid. Such a catalyst is used to exemplify the invention, other titanium supported catalyst systems are contemplated. Other catalyst use mechanisms include, but are not limited to, batch prepolymerization, in situ prepolymerization and other such mechanisms.

### Activator

In any embodiment, the catalyst systems comprise the Ziegler-Natta catalysts used in combination with an activator, also referred to herein as a Ziegler-Natta activator. In any embodiment, compounds containing at least one aluminum-carbon bond in the molecule can be utilized as the activators, also referred to herein as an organoaluminum activator or an organoaluminum compound. Suitable organoaluminum compounds include organoaluminum compounds of the general formula R¹ₘAl(OR²)ₙHₚX_{q}, wherein R¹ and R² are identical or different, and each represents a C₁ to C₁₅ hydrocarbyl radical (alkyl or aryl), a C₁ to C₄ alkyl; “X” represents a halogen atom; and “m” is 1, 2, or 3; “n” is 0, 1, or 2; “p” is 0, 1, 2, or 3; and “q” is 0, 1, or 2; and wherein m+n+p+q=3.

Other suitable organoaluminum compounds include complex alkylated compounds of aluminum represented by the general formula M1 A1R, wherein M1 is lithium, sodium, or potassium, and R1 is as defined above. Suitable organoaluminum compounds include compounds represented by the following general formula R¹ₘAl(OR²)₃₋ₘ, wherein R¹ and R² are as defined above, and m is preferably 1.5<m<3; R¹ₘAl(H)₃₋ₘ, wherein R1 is as defined above, X is halogen, and m is 0<m<3, or 2<m<3; and/or R¹ₘAl(OR²)ₙX_{q}, wherein R¹ and R² are as defined above, X is halogen, 0<m<3, 0<n<3, 0<q<3, and m+n+q=3.

Suitable examples of the organoaluminum compounds include trialkyl aluminums such as trimethyl aluminum, triethyl aluminum and tributyl aluminum; trialkenyl aluminums such as triisoprenyl aluminum; dialkyl aluminum alkoxides such as diethyl-aluminum ethoxide and dibutyl aluminum ethoxide; alkyl aluminum sesquialkoxides such as ethyl aluminum sesquiethoxide and butyl aluminum sesquibutoxide; partially alkoxylated alkyl aluminums having an average composition represented by the general formula R¹_{2.5}Al(OR²)_{0.5}; partially halogenated alkyl aluminums, for example, alkyl aluminum dihalides such as ethyl aluminum dichloride, propyl aluminum dichloride and butyl aluminum dibromide; partially hydrogenated alkyl aluminums, for example, alkyl aluminum dihydrides such as ethyl aluminum dihydride and propyl aluminum dihydride; and partially alkoxylated and halogenated alkyl aluminums such as ethyl aluminum ethoxychloride, butyl aluminum butoxychloride, and ethyl aluminum ethoxybromide.

In any embodiment, the organoaluminum compound can comprise two or more aluminum atoms bonded through an oxygen or nitrogen atom. Examples include (C₂H₅)₂AlOAl(C₂H₅)₂, (C₄H₉)₂AlOAl(C₄H₉)₂, LiAl(C₂H₅)₄, and/or methylaluminoxane (MAO). In any embodiment, the trialkyl aluminums and alkyl-aluminums resulting from bonding of at least two aluminum compounds can be used.

In any embodiment, the activator can be an organoaluminum compound that is halogen free. Suitable halogen free organoaluminum compounds are in particular, branched unsubstituted alkylaluminum compounds of the formula AIR3, where R denotes an alkyl radical having 1 to 10 carbon atoms, such as for example, trimethylaluminum, triethylaluminum, triisobutylaluminum and tridiisobutylaluminum. Additional compounds that are suitable for use as an activator are readily available and amply disclosed in the prior art including U.S. Pat. No. 4,990,477. In any embodiment, the organoaluminum Ziegler-Natta activator can be trimethyl aluminum, triethylaluminum (TEAL), or a combination thereof.

### Internal Electron Donors

Electron donors are present with the metal components described above in forming the catalyst system suitable for producing the polypropylene compositions described herein. Both “internal” and “external” electron donors are desirable for forming the catalyst system suitable for making the polypropylene compositions described herein. Internal and external-type electron donors are described, for example, in U.S. Pat. No. 4,535,068.

The internal electron donor can be used in the formation reaction of the catalyst as the transition metal halide is reacted with the metal hydride or metal alkyl. Examples of suitable internal electron donors include amines, amides, ethers, esters, ketones, nitriles, phosphines, stilbenes, arsines, phosphoramides, thioethers, thioesters, aldehydes, alcoholates, and salts of organic acids, any of which can include an aromatic group. The internal electron donors are typically part of the solid catalyst component, while the external electron donors are typically added separately from the solid catalyst component.

In any embodiment, an internal electron donor can be used in the formation reaction of the catalyst as the transition metal halide is reacted with the metal hydride or metal alkyl. Examples of suitable internal electron donors include amines, amides, ethers, esters, esters, ketones, nitriles, phosphines, stilbenes, arsines, phosphoramides, thioethers, thioesters, aldehydes, alcoholates, and salts of organic acids. In any embodiment, the internal donor can be non-aromatic. In any embodiment, the non-aromatic internal electron donor can comprise an aliphatic amine, amide, ester, ether, ketone, nitrile, phosphine, phosphoramide, thioethers, thioester, aldehyde, alcoholate, carboxylic acid, or a combination thereof.

In any embodiment, the solid titanium catalyst component can be prepared using a non-aromatic internal electron donor. Examples of suitable non-aromatic internal electron donors include oxygen-containing electron donors such as alcohols, ketones, aldehydes, carboxylic acids, esters of organic or inorganic oxides, ethers, acid amides and acid anhydrides; nitrogen-containing electron donors such as ammonia, amines, nitriles, and/or isocyanates. Suitable examples include alcohols having 1 to 18 carbon atoms such as methanol, ethanol, propanol, pentanol, hexanol, octanol, 2-ethylhexanol, dodecanol, octadecyl alcohol, and the like; ketones having 3 to 15 carbon atoms such as acetone, methyl ethyl ketone, methyl isobutyl ketone, and the like; aldehydes having 2 to 15 carbon atoms such as acetaldehyde, propionaldehyde, octylaldehyde, and the like; organic acid esters having 2 to 30 carbon atoms including the esters desired to be included in the titanium catalyst component, such as methyl formate, ethyl formate, vinyl acetate, propyl acetate, octyl acetate, cyclohexyl acetate, ethyl propionate, methyl butyrate, ethyl valerate, ethyl stearate, methyl chloroacetate, ethyl dichloroacetate, methyl methacrylate, ethyl crotonate, dibutyl maleate, diethyl butylmalonate, diethyl dibutylmalonate, ethylcyclohexanecarboxylate, diethyl 1,2-cyclohexanedicarboxylate, di(2-ethylhexyl) 1,2-cyclohexanedicarboxylate, gamma-butyrolactone, delta-valerolactone, and/or ethylene carbonate; inorganic acid esters such as ethyl silicate and butyl silicate; acid halides having 2 to 15 carbon atoms such as acetyl chloride and the like; ethers having 2 to 20 carbon atoms, such as methyl ether, ethyl ether, isopropyl ether, butyl ether, amyl ether, tetrahydrofuran and the like; acid amides such as acetamide, and the like; acid anhydrides such as acetic anhydride, and the like; amines such as methylamine, ethyl-amine, triethylamine, tributylamine, tetramethyl-ethylenediamine, and the like; and nitriles such as acetonitrile, trinitrile, and the like.

In any embodiment, the non-aromatic internal electron donor comprises a C₁ to C₂₀ diester of a substituted or unsubstituted C₂ to C₁₀ dicarboxylic acid. In any embodiment, the non-aromatic internal electron donor can be a succinate according to Formula I:

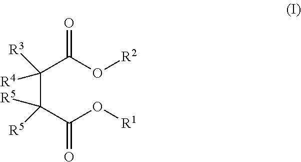

wherein R¹ and R² are independently C₁ to C₂₀ linear or branched alkyl, alkenyl, or cycloalkyl hydrocarbyl radicals; R³ to R⁶ are independently, hydrogen, halogen, or C₁ to C₂₀ linear or branched alkyl, alkenyl, or cycloalkyl hydrocarbyl radicals, wherein the R³ to R⁶ radicals are not joined together, wherein at least two of the R³ to R⁶ radicals are joined to form a cyclic divalent radical, or a combination thereof.

In any embodiment, R³ to R⁵ of Formula I can be hydrogen and R⁶ can be a radical selected from the group consistent of a primary branched, secondary or tertiary alkyl, or cycloalkyl radical having from 3 to 20 carbon atoms.

In any embodiment, the internal donor can be a monosubstituted non-aromatic succinate compound. Suitable examples include diethyl secbutylsuccinate, diethylhexylsuccinate, diethyl cyclopropylsuccinate, diethyl trimethylsilylsuccinate, diethyl methoxysuccinate, diethyl cyclohexylsuccinate, diethyl(cyclohexylmethyl)succinate, diethyl t-butylsuccinate, diethyl isobutylsuccinate, diethyl isopropylsuccinate, diethyl neopentylsuccinate, diethyl isopentylsuccinate, diethyl(1,l,ltrifluoro-2-propyl)succinate, diisobutyl sec-butylsuccinate, diisobutylhexylsuccinate, diisobutyl cyclopropylsuccinate, diisobutyl trimethylsilylsuccinate, diisobutyl methoxysuccinate, diisobutyl cyclohexylsuccinate, diisobutyl(cyclohexylmethyl)succinate, diisobutyl t-butylsuccinate, diisobutyl isobutylsuccinate, diisobutyl isopropylsuccinate, diisobutyl neopentylsuccinate, diisobutyl isopentylsuccinate, diisobutyl(1,1,1-trifluoro-2-propyl)succinate, dineopentyl see butylsuccinate, dineopentyl hexylsuccinate, dineopentyl cyclopropylsuccinate, dineopentyl trimethylsilylsuccinate, dineopentyl methoxysuccinate, dineopentyl cyclohexylsuccinate, dineopentyl(cyclohexylmethyl)succinate, dineopentyl tbutylsuccinate, dineopentyl isobutylsuccinate, dineopentyl isopropylsuccinate, dineopentyl neopentylsuccinate, dineopentyl isopentylsuccinate, and/or dineopentyl(1,1,1-trifluoro-2propyl)succinate.

In any embodiment, the internal electron donor having a structure consistent with Formula I includes at least two radicals from R³ to R⁶, which are different from hydrogen and are selected from C₁ to C₂₀ linear or branched alkyl, alkenyl, and/or cycloalkyl hydrocarbyl groups, which can contain heteroatoms. In any embodiment, two radicals different from hydrogen can be linked to the same carbon atom. Suitable examples include 2,2-disubstituted succinates including diethyl 2,2-dimethylsuccinate, diethyl 2-ethyl-2-methylsuccinate, diethyl 2-(cyclohexylmethyl)-2-isobutylsuccinate, diethyl 2-cyclopentyl-2-n-propylsuccinate, diethyl 2.2-diisobutylsuccinate, diethyl 2-cyclohexyl-2-ethylsuccinate, diethyl 2-isopropyl-2-methylsuccinate, diethyl 2,2-diisopropyl diethyl 2isobutyl-2-ethylsuccinate, diethyl 2-(1,1,1-trifluoro-2-propyl)-2-methylsuccinate, diethyl 2 isopentyl-2-isobutylsuccinate, diisobutyl 2,2dimethylsuccinate, diisobutyl 2-ethyl-2-methylsuccinate, diisobutyl 2-(cyclohexylmethyl)-2-isobutylsuccinate, diisobutyl 2-cyclopentyl-2-n-propylsuccinate, diisobutyl 2,2-diisobutylsuccinate, diisobutyl 2-cyclohexyl-2-ethylsuccinate, diisobutyl 2-isopropyl-2-methylsuccinate, diisobutyl 2-isobutyl-2-ethylsuccinate, diisobutyl 2-(1,1,1-trilluoro-2-propyl)-2-methylsuccinate, diisobutyl 2-isopentyl-2-isobutylsuccinate, diisobutyl 2,2-diisopropylsuccinate, dineopentyl 2,2-dimethylsuccinate, dineopentyl 2-ethyl-2-methylsuccinate, dineopentyl 2-(cyclohexylmethyl)-2isobutylsuccinate, dineopentyl 2-cyclopentyl-2-n-propylsuccinate, dineopentyl 2,2-diisobutylsuccinate, dineopentyl 2-cyclohexyl-2-ethylsuccinate, dineopentyl 2-isopropyl-2methylsuccinate, dineopentyl 2-isobutyl-2-ethylsuccinate, dineopentyl 2-(1,1,1-trifluoro-2-propyl)-2-methylsuccinate, dineopentyl 2,2-diisopropylsuccinate, and/or dineopentyl 2-isopentyl-2isobutylsuccinate.

In any embodiment, at least two radicals different from hydrogen can be linked to different carbon atoms between R3 and R6. Examples include R3 and R5 or R4 and R6. Suitable non-aromatic succinate compounds include: diethyl 2,3-bis(trimethylsilyl)succinate, diethyl 2.2-secbutyl-3-methylsuccinate, diethyl 2-(3,3,3-trifluoropropyl)-3-methylsuccinate, diethyl 2,3bis(2-ethylbutyl)succinate, diethyl 2,3-diethyl-2-isopropylsuccinate, diethyl 2,3-diisopropyl-2methylsuccinate, diethyl 2,3-dicyclohexyl-2-methylsuccinate, diethyl 2,3-diisopropylsuccinate, diethyl 2,3-bis(cyclohexylmethyl)succinate, diethyl 2,3-di-tbutylsuccinate, diethyl 2,3-diisobutylsuccinate, diethyl 2,3-dineopentylsuccinate, diethyl 2,3 diisopentylsuccinate, diethyl 2,3-(1-trifluoromethyl-ethyl)succinate, diethyl 2-isopropyl-3-isobutylsuccinate, diethyl 2-t-butyl-3isopropylsuccinate, diethyl 2-isopropyl-3-cyclohexylsuccinate, diethyl 2-isopentyl-3cyclohexylsuccinate, diethyl 2-cyclohexyl-3-cyclopentylsuccinate, diethyl 2,2,3,3-tetramethylsuccinate, diethyl 2,2,3,3-tetraethylsuccinate, diethyl 2,2,3,3-tetrapropylsuccinate, diethyl 2,3-diethyl-2,3-diisopropylsuccinate, diisobutyl

2,3-bis(trimethylsilyl)succinate, diisobutyl 2,2-sec-butyl-3-methylsuccinate, diisobutyl 2-(3,3,3-trifluoropropyl)-3-methylsuccinate, diisobutyl 2,3-bis(2-ethylbutyl)succinate, diisobutyl 2,3-diethyl-2 isopropylsuccinate, diisobutyl 2,3-diisopropyl-2-methylsuccinate, diisobutyl 2,3-dicyclohexyl2-methylsuccinate, diisobutyl 2,3-diisopropylsuccinate, diisobutyl 2,3-bis(cyclohexylmethyl)succinate, diisobutyl 2,3-di-t-butylsuccinate, diisobutyl 2,3-diisobutylsuccinate, diisobutyl 2,3-dineopentylsuccinate, diisobutyl 2,3diisopentylsuccinate, diisobutyl 2,3-(1,1,1-trifluoro-2-propyl)succinate, diisobutyl 2,3-n-propylsuccinate, diisobutyl 2-isopropyl-3ibutylsuccinate, diisobutyl 2-terbutyl-3-ipropylsuccinate, diisobutyl 2-isopropyl-3-cyclohexylsuccinate, diisobutyl 2-isopentyl-3-cyclohexylsuccinate, diisobutyl 2-n-propyl-3(cyclohexylmethyl)succinate, diisobutyl 2-cyclohexyl-3-cyclopentylsuccinate, diisobutyl 2,2,3,3-tetramethylsuccinate, diisobutyl 2,2,3,3-tetraethylsuccinate, diisobutyl 2,2,3,3-tetrapropylsuccinate, diisobutyl 2,3-diethyl-2,3-diisopropylsuccinate, dineopentyl 2,3-bis(trimethylsilyl)succinate, dineopentyl 2, 2-di-sec-butyl-3-methylsuccinate, dineopentyl 2(3,3,3-trifluoropropyl)-3-methylsuccinate, dineopentyl 2,3 bis(2-ethylbutyl)succinate, dineopentyl 2,3-diethyl-2-isopropylsuccinate, dineopentyl 2,3-diisopropyl-2-methylsuccinate, dineopentyl 2,3-dicyclohexyl-2-methylsuccinate, dineopentyl 2,3-diisopropylsuccinate, dineopentyl 2,3-bis(cyclohexylmethyl)succinate, dineopentyl 2,3-di-t-butylsuccinate, dineopentyl 2,3-diisobutylsuccinate, dineopentyl 2,3-dineopentylsuccinate, dineopentyl 2,3-diisopentylsuccinate, dineopentyl 2,3-(1,1,1-trifluoro-2propyl)succinate, dineopentyl 2,3-n-propylsuccinate, dineopentyl 2-isopropyl-3-isobutylsuccinate, dineopentyl 2-t-butyl-3-isopropylsuccinate, dineopentyl 2-isopropyl-3-cyclohexylsuccinate, dineopentyl 2-isopentyl-3-cyclohexylsuccinate, dineopentyl 2-n-propyl-3-(cyclohexylmethyl)succinate, dineopentyl 2-cyclohexyl-3-cyclopentylsuccinate, dineopentyl 2,2,3,3-tetramethylsuccinate, dineopentyl 2,2,3,3-tetraethylsuccinate, dineopentyl 2,2,3,3-tetrapropylsuccinate, and/or dineopentyl 2,3-diethyl 2,3-diisopropylsuccinate.

In any embodiment, the compounds according to Formula I can include two or four of the radicals R³ to R⁶ joined to the same carbon atom which are linked together to form a cyclic multivalent radical. Examples of suitable compounds include 1-(ethoxycarbonyl)-1-(ethoxyacetyl)-2,6-dimethylcyclohexane, 1-(ethoxycarbonyl)-1-(ethoxyacetyl)-2, 5-dimethyl-cyclopentane, 1-(ethoxycarbonyl)-1-(ethoxyacetylmethyl)-2-methylcyclohexane, and/or 1-(ethoxycarbonyl)-1-(ethoxy(cyclohexyl)acetyl)cyclohexane.

For purposes herein, all the above-mentioned compounds can be used either in the form of pure stereoisomers or in the form of mixtures of enantiomers, or mixture of diastereoisomers and enantiomers. When a pure isomer is to be used it can be isolated using the common techniques known in the art. In particular, some of the succinates of the present invention can be used as a pure rac or meso forms, or as mixtures thereof, respectively.

In any embodiment, the internal electron donor compound can be selected from the group of diethyl 2,3-diisopropylsuccinate, diisobutyl 2,3-diisopropylsuccinate, di-n-butyl 2,3-diisopropylsuccinate, diethyl 2,3-dicyclohexyl-2-methylsuccinate, diisobutyl 2,3-dicyclohexyl-2-methylsuccinate, diisobutyl 2,2-dimethylsuccinate, diethyl 2,2-dimethylsuccinate, diethyl 2-ethyl-2-methylsuccinate, diisobutyl 2-ethyl-2-methylsuccinate, diethyl 2-(cyclohexylmethyl)-3-ethyl-3-methylsuccinate, diisobutyl 2-(cyclohexylmethyl)-3-ethyl-3-methylsuccinate, and combinations thereof.

### External Electron Donors

In any embodiment, in conjunction with an internal donor, two or more external electron donors can also be used in combination with the catalyst in the catalyst system. External electron donors include, but are not limited to, organic silicon compounds, e.g., tetraethoxysilane (TEOS), methylcyclohexyldimethoxysilane (MCMS), propyltriethoxysilane (PTES) and dicyclopentydimethoxysilane (DCPMS). For example, in any embodiment, the external electron donor can be PTES/DCPMS, metal chelate monomers (“MCMS”), tetraethoxysilane (“TEOS”), propyltriethoxysilane (“PTES”) and/or a blend of tetraethoxysilane and DCPMS (also referred to as “TEOS)/DCPMS”) and/or others.

The use of organic silicon compounds as external electron donors is described, for example, in U.S. Pat. Nos. 4,218,339; 4,395,360; 4,328,122; and 4,473,660. The external electron donors act to control stereoregularity, which affects the amount of isotactic versus atactic polymers produced in a given system. The more stereoregular isotactic polymer is more crystalline, which leads to a material with a higher flexural modulus. Highly crystalline, isotactic polymers also display lower MFRs, as a consequence of a reduced hydrogen response during polymerization. The stereo-regulating capability and hydrogen response of a given external electron donor are directly and inversely related. The DCPMS donor has a substantially lower hydrogen response than the PTES donor, but produces a significantly higher level of stereoregularity than PTES.

In any embodiment, the two external electron donors A and B, also referred to herein as the first external electron donor and the second external electron donor, can be selected such that the melt flow rate MFR (A) of polypropylene compositions obtained by homopolymerizing propylene by using the first external electron donor (A) in combination with the solid titanium catalyst component and the organoaluminum compound catalyst component and the MFR (B) of polypropylene compositions obtained by homopolymerizing propylene by using the second external electron donor (B) under the same conditions as in the case of using the external electron donor (A) have the following relation: 1.2<log [MFR(5)/MFR(A)]<1.4.

The external electron donors to be used in the preparation of the electron donor catalyst component can be those electron donors which are used in preparing the solid titanium catalyst component. In any embodiment, each of the external electron donors (A) and (B) can comprise organic silicon compounds.

In any embodiment, one or more of the external electron donors can comprise an organic silicon compound of formula: R³ₙSi(OR⁴)₄₋ₙ> wherein R³ and R⁴ independently represent a hydrocarbyl radical and 0<n<4.

Examples of the suitable organic silicon compounds include trimethylmethoxysilane, trimethylethoxysilane, dimethyldimethoxysilane, dimethyldimethoxysilane, dimethyldiethoxysilane, diiso-propyldiethoxysilane, t-butylmethyl-n-diethoxysilane, t-butylmethyldiethoxysilane, t-amylmethyldiethoxysilane, diphenyldimethoxysilane, phenylmethyldimethoxysilane, diphenyldiethoxysilane, bis-o-tolyldimethoxysilane, bis-m-tolyldimethoxysilane, bis-p-tolyldimethoxysilane, bis-p-tolyldimethoxysilane, bisethylphenyldimethoxy-silane, dicyclohexyldiethoxysilane, cyclohexylmethyl-dimethoxysilane, cyclohexylmethyldiethoxysilane, ethyltrimethoxysilane, ethyltriethoxysilane, vinyl-trimethoxysilane, methyltrimethoxysilane, n-propyltriethoxysilane, decyltrimethoxysilane, decyltriethoxy-silane, phenyltrimethoxysilane, [gamma]-chloropropyltri-methoxysilane, methyltriethoxysilane, ethyltriethoxy-silane, vinyltriethoxysilane, t-butyltriethoxysilane, n-butyltriethoxysilane, iso-butyltriethoxysilane, phenyltriethoxysilane, gamma-aminopropyltriethoxysilane, chlorotriethoxysilane, vinyltributoxysilane, cyclo-hexyltrimethoxysilane, cyclohexyltriethoxysilane, 2-norbomanetriethoxysilane, 2-norbornanemethyldimethoxy-silane, ethyl silicate, butyl silicate, trimethyl-phenoxysilane, methylallyloxysilane, vinyltris(beta-methoxyethoxysilane), vinyltriacetoxysilane, and/or dimethyltetraethoxydisiloxane.

In any embodiment, one of the two or more organic silicon compounds can comprise the formula: R¹₂Si(OR²)₂, wherein R¹ represents a hydrocarbyl radical in which the carbon adjacent to Si is secondary or tertiary. Suitable examples include substituted and unsubstituted alkyl groups such as isopropyl, sec-butyl, t-butyl and t-amyl groups, cyclo-alkyl groups such as cyclopentyl and cyclohexyl groups, cycloalkenyl groups such as a cyclopentenyl group, and aryl groups such as phenyl and tolyl groups. In any embodiment, R² can represent a hydrocarbyl radical, or a hydrocarbyl radical having 1 to 5 carbon atoms, or a hydrocarbyl radical having 1 or 2 carbon atoms.

Examples of suitable organic silicon compounds include diisopropyldimethoxysilane, diisopropyldiethoxysilane, di-sec-butyldimethoxysilane, di-t-butyldimethoxysilane, di-t-amyldimethoxysilane, dicyclopentyldimethoxysilane, dicyclohexyldimethoxy-silane, diphenyldimethoxysilane, bis-o-tolyldimethoxy-silane, bis-m-tolyldimethoxysilane, bis-p-tolyldi-methoxysilane, and/or bis-ethylphenyldimethoxysilane.

In any embodiment, the organic silicon compound can be represented by the following general formula: R¹ₙSi(OR²)₄₋ₙ, wherein n is 2, R1 each represents a hydrocarbyl radical and at least one of the two hydrocarbyl radicals is a hydrocarbon group in which the carbon adjacent to Si is a primary carbon. Examples of suitable hydrocarbon groups include alkyl groups such as ethyl, n-propyl and n-butyl groups, aralkyl groups such as cumyl and benzyl groups, and alkenyl groups such as a vinyl group, and the like.

In any embodiment, R² can represent a hydrocarbyl radical preferably having 1 to 5 carbon atoms, or from 1 to 2 carbon atoms. Suitable examples of the organic silicon compounds in which n is 2 include diethyldimethoxysilane, dipropyldimethoxysilane, di-n-butyldimethoxysilane, dibenzyldimethoxysilane, and/or divinyldimethoxysilane.

Examples of suitable compounds when 0<n<2 or 2<n<4 include R¹ being an alkyl, cycloalkyl, alkenyl, aryl or aralkyl group and R² represents a hydrocarbyl radical having 1 to 5 carbon atoms, or 1 to 2 carbon atoms.

Suitable examples of the organic silicon compounds in which 0<n<2 or 2<n<4 include trimethylmethoxysilane, trimethylethoxysilane, methyl-phenyldimethoxysilane, methyltrimethoxysilane, t-butyl-methyldimethoxysilane, t-butylmethyldiethoxysilane, t-amylmethyldimethoxysilane, phenylmethyldimethoxysilane, cyclohexylmethyldimethoxysilane, cyclohexylmethyldi-ethoxysilane, ethyltrimethoxysilane, ethyltriethoxy-silane, vinyltriethoxysilane, methyltrimethoxysilane, methyltriethoxysilane, propyltrimethoxysilane, decyl-trimethoxysilane, decyltriethoxysilane, phenyltrimethoxysilane, propyltriethoxysilane, butyltriethoxy-silane, phenyltriethoxysilane, vinyltrimethoxysilane, vinyltributoxysilane, cyclohexyltrimethoxysilane, 2-norbomanetrimethoxysilane, and/or 2-norbornanetriethoxy-silane. In any embodiment the external electron donors include methyltrimethoxysilane, ethyltrimethoxysilane, ethyltriethoxysilane, vinyltriethoxysilane, propyltrimethoxysilane, decyl-trimethoxysilane, decyltriethoxysilane, propyltri-ethoxysilane, butyltriethoxysilane, phenyltriethoxy-silane, vinyltrimethoxysilane, vinyltributoxysilane and/or cyclohexyltrimethoxysilane.

In any embodiment, the above disclosed organic silicon compounds can be used such that a compound capable of being changed into such an organic silicon compound is added at the time of polymerizing or preliminarily polymerizing an olefin, and the organic silicon compound can be formed in situ during the polymerization or the preliminary polymerization of the olefin.

In any embodiment, a first external electron donor can have the formula R¹₂Si(OR²)₂, wherein each R¹ is independently a hydrocarbyl radical comprising from 1 to 10 carbon atoms in which the carbon adjacent to the Si is a secondary or a tertiary carbon atom, each R² is independently a hydrocarbyl radical comprising from 1 to 10 carbon atoms, and a second external electron donor having the formula R³ₙSi(OR⁴)₄₋ₙ> wherein each R³ and R⁴ are independently a hydrocarbyl radical comprising from 1 to 10 carbon atoms, and n is 1, 2, or 3, and the second external electron donor is different than the first external electron donor.

In any embodiment, the first external electron donor and the second external electron donor selected from the group of tetraethoxysilane, methylcyclohexyldimethoxysilane, propyltriethoxysilane, dicyclopentydimethoxysilane, and combinations thereof. In any embodiment, the Ziegler-Natta catalyst system can comprise 2.5 mol % to less than 50 mol % of the first external electron donor and greater than 50 mol % of a second external electron donor based on total mol % of external electron donors. In any embodiment, the first electron donor can comprise dicyclopentyldimethoxysilane (“DCPMS”) and the second external electron donor can comprise propyltriethoxysilane (“PTES”).

In any embodiment, a relationship between the first external electron donor and the second external electron donor can be defined by the equation: 1.2<log [MFR(B)/MFR(A)]<1.4, wherein MFR(A) is a first melt flow rate of a homopolymer formed by polymerizing propylene monomers in the presence of the Ziegler-Natta catalyst and the first external electron donor, and wherein MFR(B) is a second melt flow rate of a homopolymer formed by polymerizing propylene monomers in the presence of the Ziegler-Natta catalyst and the second external electron donor, and wherein the MFR(A) is lower than the MFR(B).

In any embodiment, at least one, or two or more external electron donors are used in combination with the solid Ziegler-Natta catalyst component, as long as one of them is an amino-silane donor. External donors can be added to the polymerization reactors as a separate component along with the catalyst and activator. As used herein, an “amino-silane” donor is an external electron donor having at least one amine or alkylamine moiety and at least one silane, alkylsilane or siloxane moiety. In any embodiment, the external electron donors can include an organic silicon compound of the general formula RSi and/or R¹ₙSi(NR²₂)₄₋ₙ, wherein each R¹ is independently selected from hydrogen, C₁ to C₁₀ linear and branched alkyls and alkenes, C₄ to C₁₂ cycloalkyls and cycloalkenes, C₅ to C₁₄ aryls, C₆ to C₂₀ alkylaryls, C₁ to C₁₀ linear or branched alkoxys, C₄ to C₁₂ cycloalkoxys, C₅ to C₁₄ aryloxys, and C₆ to C₂₀ alkylaryloxys; each R¹ is independently selected from C₁ to C₆ linear, branched and cyclic alkyls or alkoxys; and each R² is independently selected from hydrogen, C₁ to C₁₀ linear and branched alkyls and alkenes, C₄ to C₁₂ cycloalkyls and cycloalkenes, C₅ to C₁₄ aryls, and C₆ to C₂₀ alkylaryls; each R² is independently selected from C₁ to C₅ linear or branched alkyls; and wherein “n” is 0, 1, 2, or 3.

Examples of the suitable organic silicon and/or amino-silane compounds include dimethylamino-triethoxysilane, diethylamino-triethoxysilane, vinylethylamino-triethoxysilane, dipropylamino-triethoxysilane, dimethylamino-trimethoxysilane, dimethylamino-tripropylsilane, diethylamino-dicyclopentylmethoxysilane, diethylamino-dimethoxy-cyclohexylsilane, dipropylamino-vinyldimethoxysilane, trimethylmethoxysilane, trimethylethoxysilane, dimethyldimethoxysilane, dimethyldimethoxysilane, dimethyldiethoxysilane, diisopropyldiethoxysilane, t-butylmethyl-n-diethoxysilane, t-butylmethyldiethoxysilane, t-amylmethyldiethoxysilane, diphenyldimethoxysilane, phenylmethyldimethoxysilane, diphenyldiethoxysilane, bis-o-tolyldimethoxysilane, bis-m-tolyldimethoxysilane, bis-p-tolyldimethoxysilane, bis-p-tolyldimethoxysilane, bisethylphenyldimethoxysilane, dicyclohexyldiethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, g-chloropropyltrimethoxysilane, methyltriethoxysilane, ethyltriethoxysilane, vinyltriethoxysilane, t-butyltriethoxysilane, n-butyltriethoxysilane, isobutyltriethoxysilane, phenyltriethoxysilane, g-aminopropyltriethoxysilane, chlorotriethoxysilane, vinyltributoxysilane, cyclohexyltrimethoxysilane, cyclohexyltriethoxysilane, 2-norbomanetriethoxysilane, 2-norbornanemethyldimethoxysilane, ethylsilicate, butylsilicate, trimethylphenoxysilane, methylallyloxysilane, vinyltriacetoxysilane, dimethyltetraethoxydisiloxane, tetraethoxysilane, methylcyclohexyldimethoxysilane, propyltriethoxysilane, and/or dicyclopentyldimethoxysilane.

In any embodiment, the external electron donor can contain one or more amino-silane donors. Different external electron donors can be added in the first and/or second or more loop reactors to effect the polypropylene properties such as making the polypropylene bimodal in MFR, molecular weight, crystallinity, or some other property. In an aspect, one external electron donor is added throughout, and at the same concentration. In any embodiment, the combined concentration of external electron donors can be present with the catalyst and olefin monomer(s) in the reactor between 5 ppm, 10 ppm, 20 ppm to 80, 100, and 120 ppm, based on the total olefin concentration.

In any embodiment, the concentration of the Ziegler-Natta catalyst in the polymerization system can be 2 ppm, 4 ppm, 8 ppm to 20 ppm, 40 ppm, 60 ppm, and 100 ppm based on the total polypropylene concentration. In any embodiment, the organoaluminum activator can be present in an amount sufficient to produce between 0.1 to 500 g, and between 0.3 to 300 g of polypropylene per gram of the titanium catalyst present, and can present between 0.1 to 100 moles, and from 0.5 to 50 moles, per mole of the titanium atom present in the catalyst component. Stated another way, the organoaluminum activator can be added in the amount of ppm, 20 ppm, 40 ppm to 80 ppm, 100 ppm, 140 ppm, 180 ppm and 200 ppm based on the total polypropylene concentration.

### Multistage Polymerization

Multistage polymerization methods may include sequential polymerization processes in which one or more reactors are configured in series. Following each polymerization, the product mixture is transferred to the next reactor in series (or reaction stage) until the polypropylene composition is obtained. For example, to produce the polypropylene compositions disclosed herein, a primary polypropylene homopolymer or copolymer may be generated in a reactor or stage, while a high MW tail component is generated in a prior or subsequent reactor or stage.

Multistage polymerization processes can include one or more reactor types, including one or more slurry (or liquid) phase polymerization reactors, such as stirred tank reactors, loop reactors, and the like, and one or more gas phase polymerization reactors. For example, multistage polymerization processes can include a pre-polymerization loop, one or more slurry polymerization reactors and one or more gas phase reactors operated in series to produce a polypropylene composition. Sequential polymerization techniques can include commercial processes such as Lyondell Bassell's Spheripol™ process or ExxonMobil's sequential polyolefin polymerization.

### Slurry Polymerization Reactors

Multistage polymerization process may include one or more stages containing a slurry polymerization reactor. In a slurry polymerization, monomers (or comonomers) are polymerized, generating polyolefin particles and suspended in a mixture of unreacted monomer and the catalyst system. In some cases, the catalyst system may also become entrained within the growing particles. During slurry polymerization, the slurry is agitated to enable the transfer of reactants from the polymerization mixture and into the reacting particles. In any embodiment, a slurry polymerization reactor (or stage) may be used to generate a polypropylene homopolymer or copolymer having a molecular weight distribution between 6.5 to 8.5, while one or more other stages of the polymerization process (e.g., gas phase polymerization, slurry loop) are used to generate the high MW tail component. It is also envisioned that the high MW tail component may also be produced in a slurry polymerization reactor or stage(s).

Slurry polymerization is referred to sometimes as “bulk polymerization,” or a “bulk slurry.” Slurry polymerization is conducted in liquid polyolefin monomer with or without an inert diluent. In any embodiment, polyolefin monomers used in commercial production can contain some fraction of aliphatic hydrocarbons as impurities. For example, the propylene monomer can contain up to 5% of propane as an impurity. In some cases, aliphatic hydrocarbons and other inert components may accumulate through the recycle of unreacted polyolefin monomer. Therefore, the effluent of the slurry polymerization reactor can comprise up to 40 wt % of inert components. It is to be understood, however, that such a process is still within the meaning of “slurry polymerization.”

In some cases, slurry polymerizations may include a catalyst system containing a Ziegler-Natta catalyst and a first external electron donor. Slurry polymerization methods disclosed herein may include a polymerization temperature between 60° C. to 80° C., 62° C. to 78° C., or 65° C. to 75° C. and the pressure of the slurry polymerization reactor is typically between 430 psig to 580 psig, 450 psig to 570 psig, or 480 psig to 560 psig. However, the temperature and pressure of the slurry polymerization can vary depending on the nature of the catalyst system selected. In some cases, slurry polymerization can be performed at a temperature which is higher than the critical temperature of the polymerization medium. Such reaction conditions are often referred to as “supercritical conditions.” The phrase “supercritical fluid” is used to denote a fluid or fluid mixture at a temperature and pressure exceeding the critical temperature and pressure of said fluid or fluid mixture.

The slurry polymerization reactor can be any known reactor used for polymerization of propylene monomer. The slurry polymerization reactor can be a continuous stirred tank reactor, a loop reactor, or the like. In any embodiment, slurry polymerization can be performed in a loop reactor in which a slurry is circulated with high velocity along a closed pipe by a circulation pump. Examples of loop reactors include U.S. Pat. Nos. 4,582,816, 3,405,109, 3,324,093, EP 479186, and U.S. Pat. No. 5,391,654.

As described herein, a slurry can be withdrawn from the reactor either continuously or intermittently. Intermittent withdrawal can include the use of settling legs where the solids concentration of the slurry is allowed to increase before withdrawing a batch of the concentrated slurry from the reactor. The use of settling legs is disclosed in, for example, U.S. Pat. Nos. 3,374,211, 3,242,150, and EP 1310295. Continuous withdrawal is disclosed in, for example, EP 891990, EP 1415999, EP 1591460, and EP 1860125. In any embodiment, continuous withdrawal methods can be combined with a suitable concentration method, such as those disclosed in EP 1860125 and EP 1591460.

In the present methods, chain transfer agents such as hydrogen are used in the slurry reactor to control the molecular weight and melt flow rate of the polyolefin. Furthermore, hydrogen feed into the slurry polymerization reactor is adjusted to achieve a target melt flow rate of the polypropylene compositions. In addition, other process additives can also be introduced into the slurry polymerization reactor to facilitate a stable operation of the process such as chain transfer agents, antistatic agents, antifouling agents, scavengers, and the like.

In multistage polymerization reactions disclosed herein, the effluent from the slurry polymerization reactor containing polyolefin can be fed to subsequent stages, including a to a gas phase polymerization reactor, directly without a flash step between reactors. Other processes utilizing multistage polymerization are described, for example, in EP 887379, EP 887380, EP 887381, and EP 991684. In some cases, hydrogen is vented from the polymerization medium in an amount of at least 80 percent between slurry phase polymerization and gas phase polymerization.

### Gas Phase Polymerization Reactor—Fluidized Bed Reactors

Multistage polymerization reactions disclosed herein may include a second stage of gas phase polymerization to produce a second type of polymer in the propylene compositions disclosed herein, such as a high MW tail component. While examples may discuss gas phase polymerization as occurring subsequent to a slurry polymerization, it is envisioned that gas phase polymerization may occur at any or multiple points in a multistage polymerization.

Polyolefin particles generated in a gas phase polymerization reactor can be fluidized with the help of a fluidization gas that includes olefin monomer, comonomer(s), inert gas, and the like. In a gas phase polymerization reactor, the polymerization medium is introduced into an inlet chamber at the bottom of the reactor. In any embodiment, gas phase polymerization reactors can contain a fluidized bed that includes growing polyolefin particles containing the active catalyst located above a fluidization grid. To ensure that gas flow is uniformly distributed over the cross-sectional surface area of the inlet chamber, an inlet pipe can be equipped with a flow dividing element as disclosed in, for example, U.S. Pat. No. 4,933,149, and EP 684871.

From the inlet chamber, gas flow within a gas phase polymerization reactor is passed upwards through a fluidization grid into the fluidized bed. The purpose of the fluidization grid is to divide the gas flow evenly through the cross-sectional area of the fluidized bed. In any embodiment, the fluidization grid can be arranged to establish a gas stream to sweep along the reactor walls, as disclosed, for example, in WO 05/087361. Other types of fluidization grids are disclosed, for example, in U.S. Pat. No. 4,578,879, EP 600414, and EP 721798. An overview of fluidization bed reactor function is given in Geldart and Bayens: The Design of Distributors for Gas-fluidized Beds, Powder Technology, Vol. 42, 1985.

When fluidization gas is contacted with the bed containing active catalyst, the reactive components of the gas (e.g., propylene monomers or comonomers) will react in the presence of the catalyst to produce the second polymer fraction. Fluidized gas may be heated by the exothermic reaction.

Unreacted fluidization gas can be removed from the top of the reactor and cooled in a heat exchanger to remove the heat of reaction. Unreacted fluidized gas is cooled to a temperature which is lower than that of the bed to prevent the bed from heating because of the reaction. It is possible to cool the gas to a temperature where a part of it condenses. When the liquid droplets enter the reaction, they are vaporized. Vaporization heat contributes to the removal of the reaction heat. This kind of operation is called condensed mode and variations of it are disclosed, for example, in WO 2007/025640, U.S. Pat. No. 4,543,399, EP 699213, and WO 94/25495. In any embodiment, condensing agents can be added to a recycle gas stream, as disclosed in EP696293. The condensing agents can include non-polymerizable components, such as n-pentane, isopentane, n-butane or isobutane, and the like.

Following recovery from a heat exchanger, unreacted fluidized gas can be compressed and recycled into the inlet chamber of the reactor. Prior to the entry into a gas phase polymerization reactor, fresh reactants can also be introduced into the fluidization gas stream to compensate for the losses caused by the reaction and product withdrawal. The composition of the fluidization gas can be analyzed and used to determine whether additional gas components should be added to maintain the desired reaction conditions.

Catalyst systems can be introduced into the reactor in various ways, either continuously or intermittently, as discussed, for example, in WO 01/05845 and EP 499759. Where the gas phase polymerization reactor is a part of a reactor cascade, catalysts can be dispersed within the polypropylene particles from a preceding polymerization stage. Polypropylene particles can be introduced into the gas phase polymerization reactor as disclosed in EP 1415999 and WO 00/26258. For example, if a preceding reactor is a slurry reactor, the slurry reactor effluent can be fed directly to the fluidized bed of the gas phase polymerization reactor as disclosed amongst others in EP 887379, EP 887380, EP 887381, and EP 991684.

Polypropylene compositions can be withdrawn from the gas phase polymerization reactor either continuously or intermittently. Combinations of these methods can also be used. By way of example, continuous withdrawal is disclosed in WO 00/29452 and intermittent withdrawal is disclosed in U.S. Pat. No. 4,621,952, EP 188125, EP 250169 and EP 579426.

More specifically, the gas phase polymerization reactors can further include a disengagement zone in which the diameter of the reactor is increased to reduce the gas velocity and allow the particles that are carried from the bed with the fluidization gas to settle back to the bed. Further, level of the fluidized bed in the gas polymerization reactor can be observed by different techniques. For instance, the pressure difference between the bottom of the reactor and a specific height of the bed can be recorded over the whole length of the reactor and the bed level calculated based on the pressure difference values in order to determine a time-averaged level. In any embodiment, the level of the fluidized bed can be monitored by ultrasonic sensors or radioactive sensors. Here, instantaneous levels can be obtained, which can then be averaged over time to obtain a time-averaged bed level. In addition, gas phase polymerization reactors can include a mechanical agitator to facilitate mixing within the fluidized bed. An example of suitable agitator design is given in EP 707513.

Gas phase polymerization can also be conducted in a “fast fluidized bed reactor” in which the velocity of the fluidization gas exceeds the onset velocity of pneumatic transport. Then the whole bed is carried by the fluidization gas. The gas transports the polypropylene particles to a separation device, such as cyclone, where the gas is separated from the polypropylene particles.

In some cases, polymer compositions produced in a gas phase polymerization are transferred to a subsequent reaction zone, such as a settled bed or a fluidized bed or another fast fluidized bed reactor. The gas, on the other hand, may compressed, cooled and recycled to the bottom of the fast fluidized bed reactor. The combination of fast fluidized bed and settled bed is disclosed, for example, in WO 97/04015, WO 06/022736 and WO 06/120187.

### Gas Phase Polymerization Reactor—Settled Bed

Gas phase polymerization reactions can also be performed in a settled bed. In the settled bed the generated polyolefin flows downward in a plug flow manner in an environment containing reactive components in gaseous phase. The polyolefin powder is introduced into the bed from the top from where it flows downwards due to gravity. In any embodiment, reactants, such as monomer and comonomers, can be introduced at any point of the reactor. However, where the gas flows upwards its velocity should not exceed the minimum fluidization velocity as otherwise no downward flow of powder would be obtained. A gas buffer can be located at the top of the reactor so that reaction gas from previous polymerization zones contained in the polypropylene powder would be removed to the extent possible. The temperature of the settled bed can be controlled by adjusting the temperature and ratio of the reactant and/or inert gases introduced into the settled bed zone. Polymerization in settled bed is disclosed, for example, in EP 1633466, EP 1484343 and WO 97/04015.

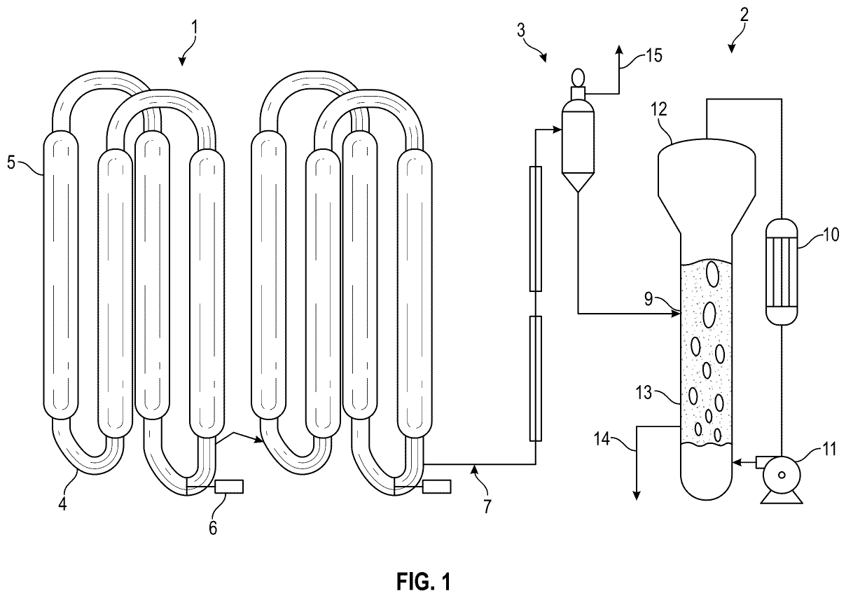

FIGS. 1, 2 and 3 are each a schematic diagrams depicting exemplary multistage polymerization processes and various reactor configurations applicable to the present disclosure. FIG. 1 shows a two-stage polymerization process including a slurry polymerization reactor stage 1 and a gas phase polymerization reactor stage 2. In this example, a polypropylene homopolymer is generated in the slurry polymerization reactor 1 with a catalyst system, while the high MW tail component is generated in the gas phase polymerization reactor 2 with comonomer addition.

As shown in FIG. 1, the slurry polymerization reactor stage 1 includes a slurry loop reactor having multiple loops 4. Each slurry loop 4 may also include a heat removal jacket 5. During polymerization in slurry reactor 1, propylene monomer (and optionally comonomers) is contacted with the catalyst system and a chain transfer agent (e.g., hydrogen) to produce an effluent 7 containing a polypropylene polymer or copolymer, hydrogen, unreacted monomers, and catalyst system. The effluent 7 is continuously fed to the gas phase polymerization reactor stage 2. Further, liquid propylene monomer (i.e., pure propylene) or propylene monomer in solution (i.e., propylene with a diluent) together with polymerization catalyst and hydrogen are cycled through the slurry polymerization reactor 1 with at least one reactor pump 6.

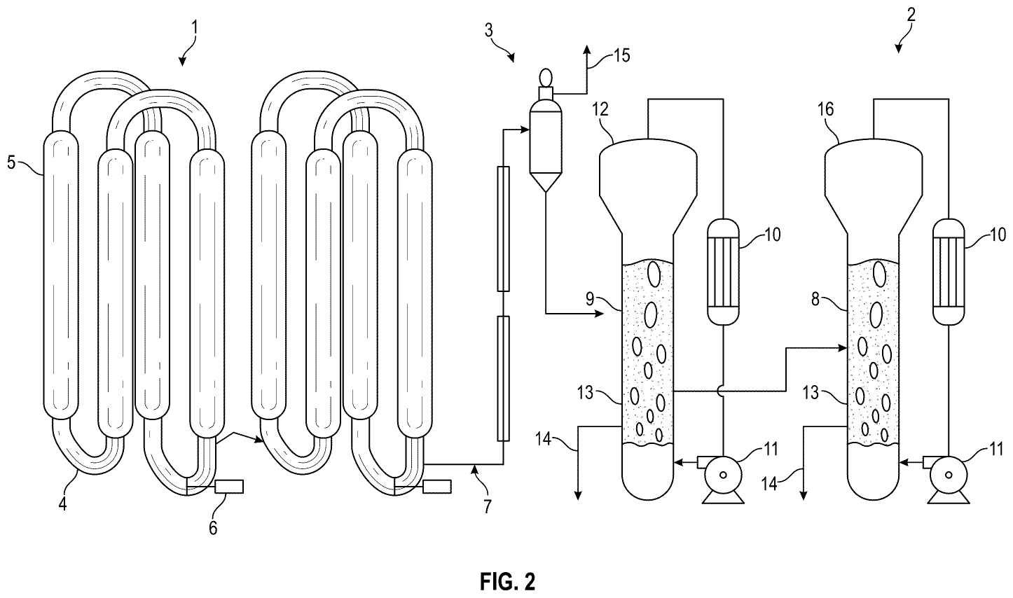

Gaseous reagents may be vented from the effluent 7 after the slurry polymerization reactor 1 and before the gas phase polymerization reactor stage 2. In any embodiment and as shown in FIGS. 1 and 2, chain transfer agent and unreacted monomer are separated from the effluent 7 through a separator 3. In the separator 3, the effluent 7 separates into a light component stream 15 containing a mixture of unreacted monomer and hydrogen, and a heavy component stream 9 containing the first polypropylene polymer and catalyst system. In any embodiment, unreacted monomer can be fed to gas phase polymerization reactor 2, including unreacted monomer recycled from the separator 3.

Following separation, as shown in FIG. 1, the first polypropylene polymer and catalyst system are fed to the inlet 9 of the gas phase polymerization reactor stage 2 to generate the high MW tail component. As depicted in FIGS. 1, 2 and 3, the gas phase polymerization reactor 12 is a vertical, cylindrical fluidized bed reactor having an expansion zone 12 above a fluidized bed 13. In the gas phase polymerization reactor stage 2, during polymerization, a polymerization medium flows into expansion zone 12. Optionally, a recycle stream taken from the top of the gas phase polymerization reactor is connected to a cooler 10 and fed to the gas phase polymerization reactor by a pump 11. Following polymerization, a polypropylene composition containing the high MW tail component may be discharged from the gas phase polymerization reactor outlet 14.

FIG. 2 provides another schematic in which a second gas phase polymerization reactor 16 is provided as a second reactor within the gas phase polymerization stage 2. Gas phase polymerization reactor 16 may serve to generate additional polymer components, including additional high MW tail. Gas phase polymerization reactor 16 may also be configured to generate additional polymer components such as an ethylene-propylene rubber for the production of impact copolymer compositions.

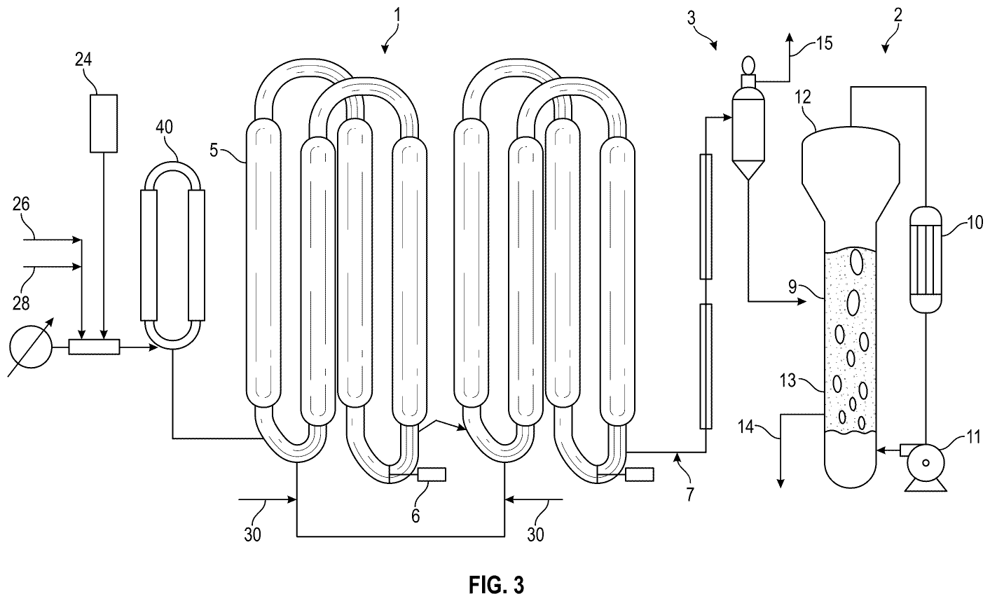

With reference to FIG. 3, a multistage process is shown in which a polypropylene monomer and polymerization medium are fed into a pre-polymerization reactor 40 by feed line 24, the catalyst system by an external donor feed line 26, and the activator by feed line 28. The preprolymerized polypropylene is then fed to slurry polymerization reactor to continue polymer chain extension. A chain transfer agent such as hydrogen is injected into the slurry polymerization reactor 1 at a reactor input 30. In some cases, the polymerization medium can include hydrogen in an amount of between 500 mppm to 10,000 mppm based on the amount of monomer feed, but below a bubble point of the system.

Gaseous reagents may be separated from the effluent 7 after the slurry polymerization reactor 1 and before the gas phase polymerization reactor 2 by separator 3. In the separator 3, the effluent 7 separates into a light component stream 15 containing a mixture of unreacted monomer and hydrogen, and a heavy component stream 9 containing the first polypropylene polymer and catalyst system. In any embodiment, the first polypropylene polymer is transferred by line 9 to the gas phase polymerization reactor 12, where the high MW tail component is generated. In the gas phase polymerization reactor stage 2, during polymerization, a polymerization medium flows into expansion zone 12. Optionally, a recycle stream taken from the top of the gas phase polymerization reactor is connected to a cooler 10 and fed to the gas phase polymerization reactor by a pump 11. Following polymerization, a polypropylene composition containing the high MW tail component may be discharged from the gas phase polymerization reactor outlet 14.

In the examples shown in FIGS. 1, 2, and 3, the high MW tail component is formed in the gas phase polymerization reactor 12 subsequent to the polypropylene polymer component, however the order of production of the components may be reversed or subdivided into differing stages without departing from the instant disclosure. For example, the high MW tail may be generated within the pre-polymerization reactor 40 and/or the slurry reactor 1, while the polypropylene polymer component is produced in a subsequent stage (e.g., slurry reactor 1 and/or gas polymerization reactor 12). Moreover, while a number of components are shown in FIGS. 1, 2 and 3, such as the compressors and pumps, the configurations are for illustrative purposes only and the apparatus and/or the process is not limited by the type of compressors and pumps used to facilitate and maintain flow of the polymerization medium, monomers, and separated polyolefins and gas.

Propylene compositions disclosed herein may also be treated with various additives to induce post-reactor modifications. Post-reactor modification techniques may include the incorporation of cross-links and branching through reaction with a crosslinking reagent such as peroxides, azides, maleic anhydride, amines, and mixtures thereof.

Polypropylene compositions disclosed herein may also include one or more additives in one or more stages of a multistage polymerization process and/or before or after polymerization. Suitable additives may include mechanical and rheological modifiers such as carbon nanomaterials such as carbon nanotubes, graphene, fullerenes, diamond-like carbon, or carbon black, fibers, nanocrystalline cellulose, cellulose nanofibrils, silica, silica-alumina, alumina such as (pseudo)boehmite, gibbsite, titania, zirconia, cationic clays or anionic clays such as saponite, bentonite, kaoline, sepiolite, hydrotalcite, and the like. Additives may also include metal oxides such as alumina trihydrate (ATH), aluminum monohydrate, magnesium hydroxide, magnesium silicate, talc, silicas such as fumed silica and precipitated silica, and calcium carbonate, calcium metasilicate, Wollastonite, Dolomite, Perlite, hollow glass spheres, kaolin, and the like.

Other additives may include fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers such as titanium oxide, zinc oxide, benzophenones, benzotriazoles, aryl esters, sterically hindered amines, the like; heat stabilizers; anti-blocking agents; release agents; anti-static agents; pigments; colorants; dyes; waxes; silica; fillers; talc; and the like.

### Physical Properties

Polypropylene compositions produced by the methods described herein can have a weight average molecular weight as measured by GPC-DRI of about 50 kDa or more. Polypropylene compositions may have a weight average molecular weight (M_{w}) in a range of about 50 kDa to about 1 MDa, about 100 kDa to about 1 MDa, or about 100 kDa to about 900 kDa. In any embodiment, polypropylene compositions produced with the present methods can have a MWD (M_{w}/Mₙ), as measured by GPC-DRI, of about 10 or more, about 15 or more, or about 18 or more.

Polypropylene compositions prepared by the instant methods can have a multimodal molecular weight distribution with more than one peak or inflection point, such as a high molecular weight tail. In any embodiment, the high molecular weight tail of the polypropylene compositions has a z-average molecular weight (M_{z}) as measured by GPC-DRI greater than 300 about kDa, greater than about 400 kDa, greater than about 500 kDa, or greater than about 800 kDa.

Polypropylene compositions produced by the present methods can have a melt flow rate at 230° C., 2.16 kg, as calculated according to ASTM 1238-20, between 0.1 g/10 min to 100 g/10 min, 0.1 g/10 min to 75 g/10 min, 0.1 g/10 min to 50 g/10 min, or 1 g/10 min to 50 g/10 min.

Polypropylene compositions disclosed herein may exhibit improved strain hardening as evidenced in the increased peak extensional viscosity. Polypropylene compositions disclosed herein may have a peak extensional viscosity (non-annealed) at a strain rate of 1/sec (190° C.) of greater than about 50 kPa·s, greater than about 55 kPa·s, greater than about 65 kPa·s, greater than about 75 kPa·s, or greater than about 100 kPa·s. Polypropylene compositions may have a peak extensional viscosity (non-annealed) at a strain rate of 1/sec (190° C.) having an lower limit selected from any one of about 50 kPa·s, about 55 kPa·s, or about 60 kPa·s, to an upper limit of any one of about 100 kPa·s, about 150 kPa·s, about 200 kPa·s, or about 250 kPa·s, wherein any lower limit may be combined with any upper limit.

Polypropylene compositions disclosed herein may exhibit a strain hardening ratio of about 1.5 or greater, about 1.8 or greater, or about 2.0 or greater.

Polypropylene compositions disclosed herein may exhibit an increased melt strength within the range from about 2.5 cN to about 100 cN, about 5 cN to about 100 cN, or about 10 cN to about 100 cN.

Polypropylene compositions disclosed herein may exhibit an ASTM D790A-20 flexural modulus is greater than about 1200, about 1400, or about 1500.

Embodiments disclosed herein include:
Embodiment A: A polymer composition comprising: a first polymer component comprising polypropylene; a second polymer component comprising a high molecular weight copolymer having a weight average molecular weight of greater than about 1 MDa; wherein the polymer composition has a peak extensional viscosity (non-annealed) at a strain rate of 1/see (190° C.) of greater than 55 kPa·s.
Embodiment B: A method comprising: preparing a polypropylene composition by a multistage polymerization comprising a first stage generating a propylene polymer, and a second stage generating a high molecular weight copolymer having a weight average molecular weight of greater than about 1 MDa; wherein the polymer composition has a peak extensional viscosity (non-annealed) at a strain rate of 1/sec (190° C.) of greater than 55 kPa·s.

Embodiments A and B may have one or more of the following additional elements in any combination.

Element 1: wherein the second polymer component comprises a polypropylene copolymer.

Element 2: wherein the second polymer component comprises one or more comonomers selected from one or more of ethylene, propylene, butene, hexene, octene, butadiene, norbornene, ethylidene norbornene, vinyl norbornene, 1,4-hexadiene, 1,5-hexadiene, 1,6-heptadiene, 1,6-octadiene, 1,7-octadiene, 1,8-nonadiene, 1,9-decadiene, 1,11-docadiene.

Element 3: wherein the peak extensional viscosity (non-annealed) at a strain rate of 1/sec (190° C.) is greater than 75 kPa·s.

Element 4: wherein the second polymer component is present at a percent by weight of the polymer composition (wt %) of about 2 wt % or greater.

Element 5: wherein the polymer composition has an Mw/Mn of about 10.0 or more.

Element 6: wherein the polymer composition has a melt strength within the range from 10 cN to 100 cN.

Element 7: wherein the ASTM D790A flexural modulus is greater than about 1500.

Element 8: wherein the strain hardening ratio is about 1.5 or greater.

Element 9: wherein the second stage comprises a pre-polymerization reactor.

Element 10: wherein the second stage comprises a slurry loop reactor.

Element 11: wherein the second stage comprises a gas phase polymerization reactor.

Element 12: wherein the first stage comprises a molar ratio of chain transfer agent to monomer reactant between about 0 to about 0.5.

Element 13: wherein the high molecular weight copolymer comprises an ethylene propylene copolymer.

Element 14: wherein the high molecular weight copolymer is present at a percent by weight of the polymer composition (wt %) of about 2 wt % or greater.

Element 15: wherein the polypropylene composition has an ASTM D790A flexural modulus of greater than about 1500.

Element 16: further comprising post-processing the polypropylene composition with a peroxide agent.

Element 17: wherein the polymer composition has an M_{w}/Mₙ of about 10.0 or more.

By way of non-limiting example, exemplary combinations applicable to A include, but are not limited to, 1 and any one or more of 2 to 8; 2 and any one or more of 1 and 3 to 8; 3 and any one or more of 1 to 2 and 4 to 8; 4 and any one or more of 1 to 3 and 5 to 8; 5 and any one or more of 1 to 4 and 6 to 8; 6 and any one or more of 1 to 5 and 7 to 8; 7 and any one or more of 1 to 6 and 8; 8 and any one or more of 1 to 7. Exemplary combinations applicable to B include, but are not limited to, 9 and any one or more of 1 to 8 and 10 to 17; 10 and any one or more of 1 to 9 and 11 to 17; 11 and any one or more of 1 to 10 and 12 to 17; 12 and any one or more of 1 to 11 and 13 to 17; 13 and any one or more of 1 to 12 and 14 to 17; 14 and any one or more of 1 to 13 and 15 to 17; 15 and any one or more of 1 to 14 and 16 to 17; 16 and any one or more of 1 to 15 and 17; 17 and any one or more of 1 to 16;

To facilitate a better understanding of the present disclosure, the following examples of preferred or representative embodiments are given. In no way should the following examples be read to limit, or to define, the scope of the invention.

### EXAMPLES

In the following examples, polymerization conditions were used to vary the proportion of high MW tail for a number of polypropylene compositions.

### Comparative Example 1: MFR Effects on Proportion of High MW Tail

In the following comparative example, polypropylene having a high MW was generated by combining Z/N 168 catalyst with F donor to produce a PP with broad MWD and a high molecular tail. Samples were generated at pilot plant conditions, in a continuous stirred tank reactor (CSTR). The magnesium chloride supported titanium catalyst sold commercially as Avant ZN-168M is utilized with an external donor blend of propyltriethoxysilane and dicyclopentyldimethoxysilane.

The catalyst composition preparation was carried out continuously by contacting the catalyst solids, triethylaluminum, and the external electron donor system under the conditions known in the art to yield active, stereospecific catalyst for polymerization of propylene. The activated catalyst was continuously fed to a prepolymerization reactor where it was polymerized in propylene to a productivity of approximately 100 to 300 g-polymer/g-cat. The prepolymerized catalyst was then continuously fed to a continuously stirred tank reactor and polymerization continued at a reactor temperature of 70° C. to yield homopolymer. Hydrogen was supplied as a chain transfer agent. The reactor slurry was continuously removed from the polymerization reactor and the homopolymer granules are continuously separated from the liquid propylene. The granules were passed through a dryer to remove the residual monomer and collected in Gaylord boxes.

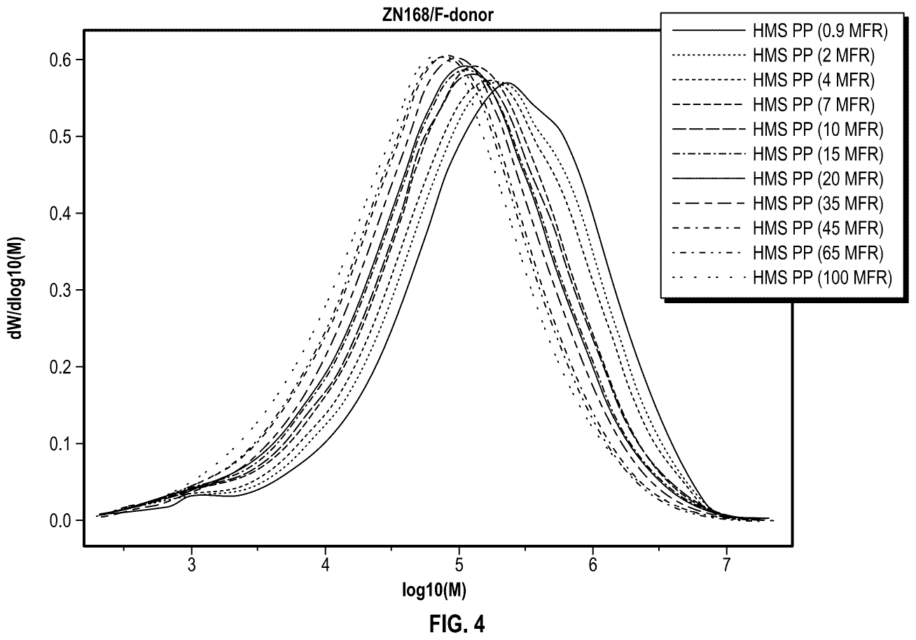

The fraction of high MW tail is summarized in Table 1. The corresponding molecular weight distribution are also graphically represented as the relative mass fraction as a function of log molecular weight in FIG. 4.

TABLE 1
High MW fraction (>1 MDa) in Example 1 polymer samples.

| Sample | Fraction of high MW polymer (%) |
|---|---|
| HMS PP (0.9 MFR) | 4.3 |
| HMS PP (2 MFR) | 3.3 |
| HMS PP (4 MFR) | 3.1 |
| HMS PP (7 MFR) | 2.1 |
| HMS PP (10 MFR) | 2.2 |
| HMS PP (15 MFR) | 1.8 |
| HMS PP (20 MFR) | 1.8 |
| HMS PP (35 MFR) | 1.3 |
| HMS PP (45 MFR) | 1.0 |
| HMS PP (65 MFR) | 0.9 |
| HMS PP (100 MFR) | 0.7 |

As the comparative results show, while the combination of catalyst and donor generate a broad and biomodal MWD, the concentration of the high MW tail decreases as the concentration of chain transfer agent decreases and MFR of the PP increases.

### Example 1: Multi-Stage Polymerization of Polypropylene Compositions

In the next example, a polypropylene composition in accordance with the present disclosure was produced in a multi-stage polymerization having a first stage containing a series of slurry loop reactors producing a polypropylene polymer, followed by a second stage having a series of gas phase reactors generating the high MW tail. In this example, the high MW tail was generated from a mixture of propylene and ethylene comonomer. The process conditions used in this example are provided below in Tables 2A-2B.

TABLE 2A

| | Slurry Reactor R102 Process Conditions | | | | |
|---|---|---|---|---|---|
| | Temp. | Pressure | Tau | H2 in Vapor | H2 in Liquid |
| Sample | F. | psig | Hr | mppm | mppm |
| C1 | 158 | 456 | 1.29 | 40759 | 4289 |
| C2 | 158 | 470 | 1.26 | 40619 | 4250 |
| C3 | 158 | 482 | 1.30 | 57274 | 6048 |
| E1 | 158 | 475 | 1.28 | 57342 | 6047 |
| E2 | 158 | 478 | 1.27 | 57305 | 6013 |
| E3 | 158 | 479 | 1.24 | 60397 | 6346 |

TABLE 2B

| | Gas Phase reactor R123 | | | | | | |
|---|---|---|---|---|---|---|---|
| | Process Conditions | | | | | | |
| | | | Bed | GPR | C2 = | | Atmer |
| | Temp. | Press. | Weight | Tau | Concentration | H2 in | (4.8%) |
| Sample | F. | psig | lb | Hr | mol % | Vapor | g/hr |
| C1 | — | — | — | — | — | — | — |
| C2 | 175 | 250 | 100 | 3.58 | 0 | 0 | 35 |
| C3 | 175 | 250 | 100 | 3.19 | 0 | 0 | 34 |
| E1 | 175 | 249 | 100 | 2.89 | 1 | 0 | 34 |
| E2 | 175 | 250 | 100 | 3.34 | 2 | 0 | 35 |
| E3 | 175 | 250 | 100 | 2.63 | 4 | 0 | 35 |

For comparative sample C, no additional high MW tail was added. For comparative samples C2 and C3, additional high MW tail added by separate reactor. For exemplary samples E1-E3 prepared in accordance with the present disclosure, additional high MW tail was added by a separate reactor with the addition of ethylene.

As shown, the additional ethylene monomer has a greater reactivity with the selected catalyst, resulting in increased fractions of high MW tail, in addition to increased M_{z}.

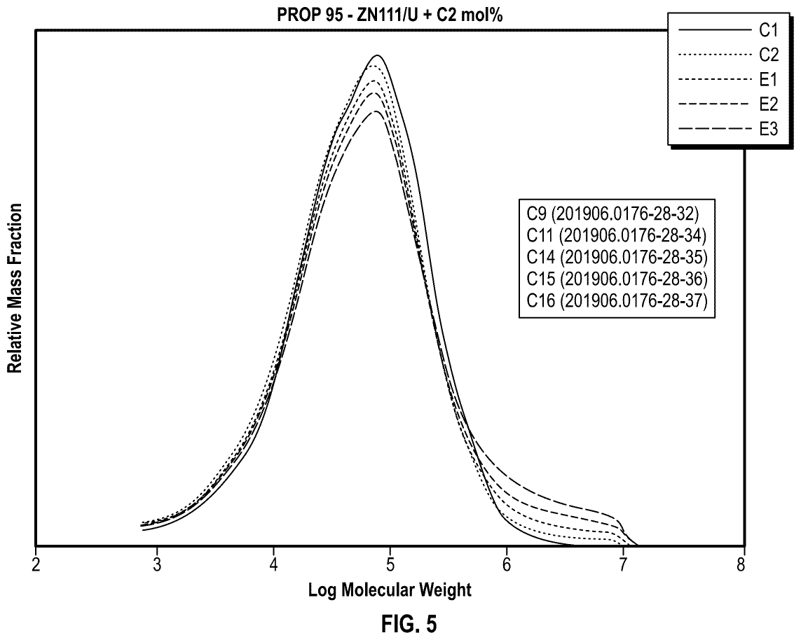

Formulation data is shown in Table 2B, while molecular weight data is provided in Table 2C. The corresponding molecular weight distribution for the samples are also graphically represented as the relative mass fraction as a function of log molecular weight in FIG. 5, indicating the enhanced high MW tail fractions for E1-E3.

TABLE 2C
Formulation data for Example 1

| | | MFR (dg/min) | | FTIR Ethylene |
|---|---|---|---|---|
| | | | BLC | Content |
| Condition | Catalyst/Donor | R102 | Final | (wt %) |
| C1 (hPP) | ZN-111/U | 230 | 212 | — |
| C2 | ZN-111/U | 215 | 94 | — |
| C3 | ZN-111/U | 386 | 203 | — |
| E1 (1 mol % C2) | ZN-111/U | 389 | 108 | 2.4 |
| E2 (2 mol % C2) | ZN-111/U | 379 | 85 | 2.6 |
| E3 (4 mol % C2) | ZN-111/U | 394 | 56 | 10.5 |

TABLE 2D
Molecular weight data for Example 1

| | Fraction | | | | | |
|---|---|---|---|---|---|---|
| | High MW | Mw | Mn | | Mz | Mz1 |
| Sample | (>1 MDa) | (g/mol) | (g/mol) | Mw/Mn | (g/mol) | (g/mol) |
| C1 | 0.008 | 125200 | 21700 | 5.8 | 515000 | 1728600 |
| C2 | 0.021 | — | — | — | — | — |
| C3 | 0.017 | 149400 | 19600 | 7.6 | 1687400 | 5600300 |
| C14 | 0.033 | 209500 | 19300 | 10.8 | 2694600 | 6336900 |
| C15 | 0.049 | 280500 | 20300 | 13.8 | 3408000 | 6712600 |
| C16 | 0.067 | 348100 | 20700 | 16.8 | 3707000 | 6685200 |

### Example 2: Bimodal High Melt Strength Polypropylenes with Strain Hardening

In the following example, additional polymers were surveyed, including additional polymers produced with a THC-133 titanium catalyst type, which included a phthalate internal electron donor and a methyl cyclohexyl dimethoxy silane as an external electron donor. The process conditions are show below in Tables 3A and 3B.

TABLE 3A
Slurry Reactor Process Data

| | | | H2 | | Atmer ppm to |
|---|---|---|---|---|---|
| | Temp | Pressure | Conc. in | Residence | Rx granules |
| Sample | (° F.) | (psig) | Vapor | Time | (wppm) |
| C4 | — | — | — | — | — |
| C5 | 158 | | | | — |
| C6 | 158 | 436 | 12864 | 1 | 98 |
| C7 | 158 | 429 | 5557 | 1 | 108 |
| C8 | 158 | 432 | 6489 | 1 | 106 |
| C9 | | | | | |
| C10 | 158 | 443 | 22203 | 1 | 96 |
| C11 | 158 | 443 | 22126 | 1 | 100 |
| C12 | 158 | 435 | 13486 | 1 | 85 |
| C13 | — | — | — | — | — |
| C14 | 158 | 462 | 41655 | 1 | — |
| E4 | 158 | 489 | 84789 | 1 | 88 |
| E5 | 158 | 488 | 75285 | 1 | 89 |

TABLE 3B
Gas Phase Reactor Process Data

| | | | | | | | | | Atmer |
|---|---|---|---|---|---|---|---|---|---|
| | | | | | | | | | ppm to |
| | | | Bed | | | | | | Rx |
| | Temp | Pressure | Mass | C2 = | C3 = | H2 | N2 | Residence | granules |
| Sample | (° F.) | (psig) | (lbs) | Conc | Conc | Conc | Conc | Time | (wppm) |
| C4 | — | — | — | — | — | — | — | — | — |
| C5 | — | — | — | — | — | — | — | — | — |
| C6 | 175 | 251 | 99 | 4 | 81 | 0 | 15 | 3.0 | 98 |
| C7 | 175 | 250 | 95 | 4 | 79 | 0 | 17 | 2.9 | 108 |
| C8 | 175 | 250 | 94 | 4 | 78 | 0 | 18 | 2.9 | 106 |
| C9 | | | | | | | | | |
| C10 | 175 | 250 | 97 | 4 | 82 | 0 | 15 | 2.8 | 96 |
| C11 | 175 | 250 | 95 | 4 | 80 | 0 | 17 | 2.9 | 100 |
| C12 | 175 | 250 | 100 | 4 | 80 | 0 | 17 | 2.4 | 85 |
| C13 | — | — | — | — | — | — | — | — | — |
| C14 | — | — | — | — | — | — | — | — | — |
| E4 | 175 | 250 | 94 | 4 | 83 | 0 | 14 | 2.5 | 88 |
| E5 | 175 | 249 | 97 | 4 | 84 | 0 | 13 | 2.6 | 89 |

Results are shown in Tables 3C to 3E. The extensional viscosity as a function of time is also shown for E4, indicating enhanced an entanglement response indicative of the high MW tail fraction.

TABLE 3C
Physical properties for samples in Example 2

| | | | PTL MFR | Flexural | |
|---|---|---|---|---|---|
| | | | ASTM | Modulus @ 0.05 | HDT (C) |
| | Modal/Polymer | Catalyst/ | D1238 | in/min, ASTM | ASTM |
| Sample | Type | Donor | (g/10 min) | D790A (MPa) | D648 |
| C4 | Monomodal hPP | THC133/C | 2.1 | 1870 | 112 |
| C5 | Monomodal hPP | ZN168M/F | 1.7 | 1810 | 104.4 |
| C6 | Bimodal RCP | ZN168M/F | 1.6 | 1450 | 106.8 |
| C7 | Bimodal RCP | THC133/F | 1.6 | 1260 | 90.0 |
| C8 | Bimodal RCP | THC133/F | 2.0 | 1400 | 101.6 |
| C9 | Monomodal hPP | ZN168M/F | 4.9 | 1960 | 112.5 |
| C10 | Bimodal RCP | ZN168M/F | 5.3 | 1640 | 115.0 |
| C11 | Bimodal RCP | ZN168M/F | 4.2 | 1540 | 109.5 |
| C12 | Bimodal RCP | THC133/F | 6.0 | 1450 | 102.5 |
| C13 | Monomodal hPP | — | 35 | 1410 | 94.5 |
| C14 | Monomodal hPP | ZN168M/F | 42.8 | 2160 | 121.1 |
| E4 | Bimodal RCP | ZN168M/F | 33.8 | 1700 | 114.5 |
| E5 | Bimodal RCP | THC133/F | 37.4 | 1650 | 117.1 |

TABLE 3D
Physical properties for samples in Example 2

| | Notched Izod | | | |
|---|---|---|---|---|
| | Impact, ASTM | | | |
| | D256, | | | |
| | Method A @ | Tensile Strength | Elongation @ | Melt |
| | 23 C. ASTM | @ Yield ASTM | Yield (%) ASTM | Strength |
| Sample | D256A | D1238 (psi) | D1238 | (cN) |
| C4 | 1.2 | 5500 | 8.4 | 5.4 |
| C5 | 0.8 | 5399 | 9.4 | 46 |
| C6 | 1.5 | 4804 | 10.2 | 34 |
| C7 | 2.1 | 4430 | 11.3 | 12.5 |
| C8 | 1.6 | 4722 | 10.0 | 11.6 |
| C9 | 0.7 | 5588 | 7.2 | 4.9 |
| C10 | 0.9 | 5261 | 8.1 | 12.4 |
| C11 | 1.0 | 5107 | 8.5 | 14.1 |
| C12 | 1.0 | 4958 | 8.8 | 7 |
| C13 | 0.49 | 5020 | 9.9 | |
| C14 | 0.7 | | — | 3 |
| E4 | 0.5 | 5150 | 6.9 | 11 |
| E5 | 0.6 | 5239 | 7.1 | 4.4 |

TABLE 3E
Molecular weight properties for samples in Example 2

| | | | | | | Tm1 | Tm2 | Tc |
|---|---|---|---|---|---|---|---|---|
| Sample | Mn | Mw | Mw/Mn | Mz | Mz + 1 | (C) | (C) | (C) |
| C4 | 74398 | 448819 | 6.0 | 1676326 | 4120723 | | 164.3 | 125.9 |
| C5 | 41579 | 433611 | 10.4 | 1426381 | 2472349 | 165.6 | 165.0 | 123.0 |
| C6 | 43072 | 676754 | 15.7 | 3851348 | 6910913 | 166.3 | 164.9 | 124.5 |
| C7 | 61146 | 641114 | 10.5 | 3576775 | 6710074 | 165.6 | 164.4 | 122.1 |
| C8 | 56363 | 603151 | 11.1 | 3512957 | 6811302 | 165.3 | 165.0 | 122.9 |
| C9 | 38914 | 325476 | 8.4 | 1028478 | 1832570 | 166.6 | 164.9 | 124.4 |
| C10 | 33863 | 400245 | 11.8 | 1968151 | 3771972 | 166.4 | 164.4 | 125.0 |
| C11 | 29894 | 551736 | 18.5 | 3739427 | 6753765 | 167.5 | 165.4 | 122.9 |
| C12 | 47091 | 453856 | 9.6 | 3202877 | 6611876 | 166.4 | 164.5 | 123.5 |
| C13 | — | — | 5 | — | — | — | — | — |
| C14 | 21229 | 200299 | 9.4 | 8099225 | 1550026 | 167.9 | 163.7 | 124.3 |
| E4 | 13167 | 372627 | 28.3 | 3948697 | 7072208 | 165.2 | 162.2 | 123.9 |
| E5 | 24494 | 312023 | 12.7 | 3324486 | 6817146 | 165.5 | 163.7 | 124.5 |

### Example 3: Bimodal High Melt Strength Polypropylenes with Strain Hardening

In the following example, the extensional viscosity was analyzed for C15, a comparative sample prepared using a catalyst associated with increased high MW tail production. Sample E6 was produced in accordance with the present disclosure utilizing the same catalyst as C15, but in a multistage polymerization process in which ethylene was introduced in a second stage gas phase polymerization with added ethylene. E7 was produced similarly to E6, but utilizing a titanium catalyst. Table 4 shows the properties measured in Example 3.

TABLE 4
Physical properties for samples measured in Example 3

| Sample | Catalyst/Donor | MWD | MFR (g/mol) | MS (cN) |
|---|---|---|---|---|
| C15 | ZN-168/F | Monomodal | 1.7 | — |
| E6 | ZN-168/F | Bimodal | 1.6 | 34 |
| E7 | THC-133/F | Bimodal | 1.6 | 13 |

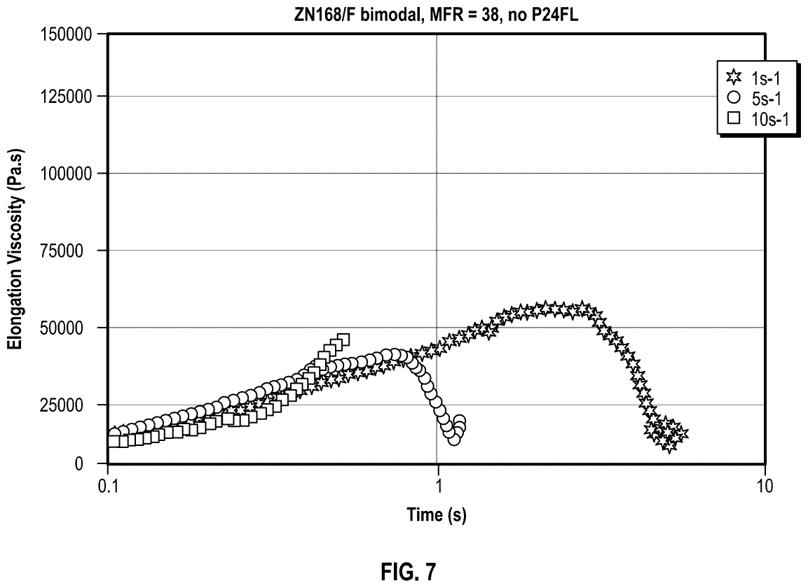

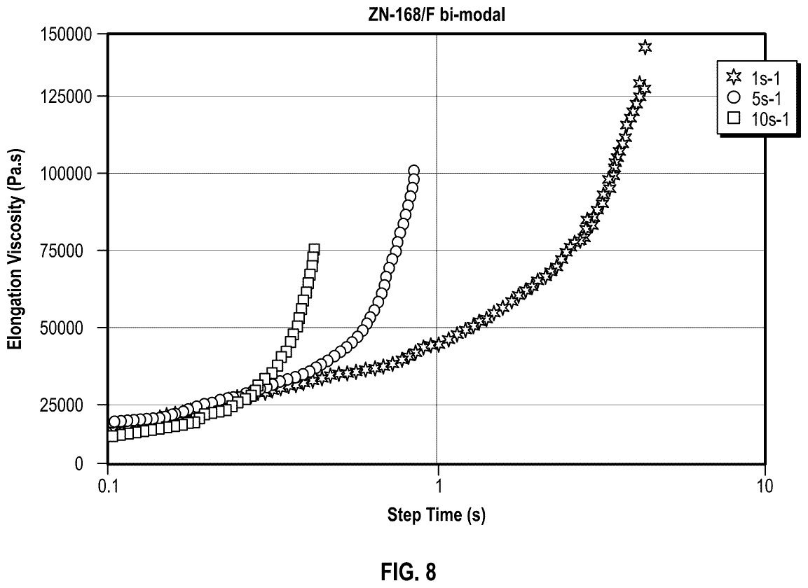

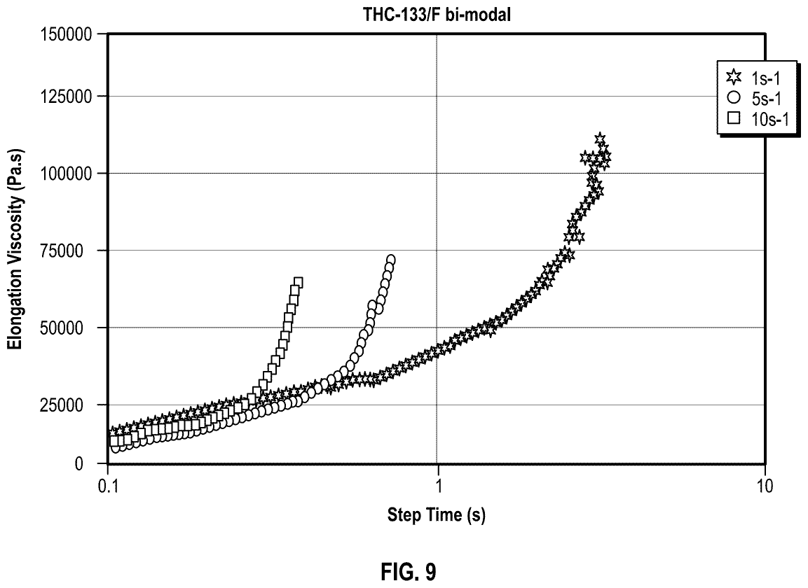

The results are plotted in FIGS. 7-9 in which elongation viscosity as a function of time is shown for each of the samples. FIG. 7 illustrates the results for C15, indicating a lack of strain hardening performance and extensional viscosity correlating to low entanglement behavior. FIG. 8 illustrates the results for E6 and FIG. 9 illustrates the results for E7, which both indicate enhanced strain hardening and entanglement behavior indicative of increased concentrations of high MW tail.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

1. A polymer composition comprising:
a first polymer component comprising polypropylene;
a second polymer component comprising a high molecular weight copolymer having a weight average molecular weight of greater than about 1 MDa;
wherein the polymer composition has a peak extensional viscosity (non-annealed) at a strain rate of 1/sec (190° C.) of greater than 55 kPa·s.

2. The polymer composition of claim 1, wherein the second polymer component comprises a polypropylene copolymer.

3. The polymer composition of claim 1, wherein the second polymer component comprises one or more comonomers selected from one or more of ethylene, propylene, butene, hexene, octene, butadiene, norbornene, ethylidene norbornene, vinyl norbornene, 1,4-hexadiene, 1,5-hexadiene, 1,6-heptadiene, 1,6-octadiene, 1,7-octadiene, 1,8-nonadiene, 1,9-decadiene, and 1,11-docadiene.

4. The polymer composition of claim 1, wherein the peak extensional viscosity (non-annealed) at a strain rate of 1/sec (190° C.) is greater than 75 kPa·s.

5. The polymer composition of claim 1, wherein the second polymer component is present at a percent by weight of the polymer composition (wt %) of about 2 wt % or greater.

6. The polymer composition of claim 1, wherein the polymer composition has an M_{w}/Mₙ of about 10.0 or more.

7. The polymer composition of claim 1, wherein the polymer composition has a melt strength within the range from 10 cN to 100 cN.

8. The polymer composition of claim 1, wherein the polymer composition has an ASTM D790A flexural modulus of greater than about 1500.

9. The polymer composition of claim 1, wherein the strain hardening ratio is about 1.5 or greater.

10. The polymer composition of claim 1, wherein the polymer composition has an M_{w}/Mₙ of about 10.0 or more.

11. A method comprising:
preparing a polypropylene composition by a multistage polymerization comprising
a first stage generating a propylene polymer, and
a second stage generating a high molecular weight copolymer having a weight average molecular weight of greater than about 1 MDa;
wherein the polymer composition has a peak extensional viscosity (non-annealed) at a strain rate of 1/sec (190° C.) of greater than 55 kPa·s.

12. The method of claim 11, wherein the second stage comprises a pre-polymerization reactor.

13. The method of claim 11, wherein the second stage comprises a slurry loop reactor.

14. The method of claim 11, wherein the second stage comprises a gas phase polymerization reactor.

15. The method of claim 11, wherein the first stage comprises a molar ratio of chain transfer agent to monomer reactant between about 0 to about 0.5.

16. The method of claim 11, wherein the high molecular weight copolymer comprises one or more comonomers selected from one or more of ethylene, propylene, butene, hexene, octene, butadiene, norbornene, ethylidene norbornene, vinyl norbornene, 1,4-hexadiene, 1,5-hexadiene, 1,6-heptadiene, 1,6-octadiene, 1,7-octadiene, 1,8-nonadiene, 1,9-decadiene, 1,11-docadiene.

17. The method of claim 11, wherein the high molecular weight copolymer comprises an ethylene propylene copolymer.

18. The method of claim 11, wherein the high molecular weight copolymer is present at a percent by weight of the polymer composition (wt %) of about 2 wt % or greater.

19. The method of claim 11, wherein the polypropylene composition has an ASTM D790A flexural modulus of greater than about 1500.

20. The method of claim 11, further comprising post-processing the polypropylene composition with a peroxide agent.
